(19) United States
(12) Patent Application Publication
(10) Pub. No.: US 2023/0232448 A1
(43) Pub. Date: Jul. 20, 2023

(54) CENTRALIZED CHANNEL ACCESS

(71) Applicant: QUALCOMM Incorporated, San Diego, CA (US)

(72) Inventors: Stelios STEFANATOS, San Diego, CA (US); Arthur GUBESKYS, San Diego, CA (US); Shuanshuan WU, San Diego, CA (US); Kapil GULATI, Belle Mead, NJ (US)

(21) Appl. No.: 17/996,587

(22) PCT Filed: Jun. 23, 2021
(86) PCT No.: PCT/US2021/038762

§ 371 Date: Oct. 19, 2022

(30) Foreign Application Priority Data
Jun. 24, 2020 (GR) 20200100362

(51) Int. Cl. H04W 74/08; H04W 72/25; H04W 72/0453; H04W 8/00; H04W 74/00

(52) U.S. Cl. CPC H04W 74/0808; H04W 72/25; H04W 72/0453; H04W 8/005; H04W 74/002

(57) ABSTRACT

Certain aspects of the present disclosure provide techniques for sidelink communications in an unlicensed spectrum. A method that may be performed by a user equipment (UE) and a base station (BS) includes sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication.

### CROSS-REFERENCE TO RELATED APPLICATION(S)

This application claims benefit of and priority to Greek Patent Application Serial No. 20200100362, filed Jun. 24, 2020, herein incorporated by reference in its entirety as if fully set forth below and for all applicable purposes.

### INTRODUCTION

Aspects of the present disclosure relate to wireless communications, and more particularly, to techniques for reserving intervals of time for wireless communication between devices.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) long term evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless communication devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims, which follow, some features will now be discussed briefly. After considering this discussion, and particularly after reading the section entitled “Detailed Description” one will understand how the features of this disclosure provide advantages.

Certain aspects relate to a wireless communication device. In some examples, the wireless communication device includes a memory and a processor coupled to the memory. In certain aspects, the processor and the memory are configured to sense, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication. In certain aspects, the processor and the memory configured to transmit one of a data signal or a reservation signal over the one or more unassigned resources of the plurality of resources when the frequency band is sensed as idle.

Certain aspects relate to a user equipment (UE). In some examples, the UE includes a memory and a processor communicatively coupled to the memory. In certain aspects, the processor and the memory are configured to receive a signal indicating a presence of a wireless communication device. In certain aspects, the processor and the memory are configured to transmit a request for one or more resources of a frequency band for performing sidelink communication in response to receiving the signal. In certain aspects, the processor and the memory are configured to receive an indication of one or more assigned resources of the frequency band from the wireless communication device, in response to the request.

Certain aspects relate to a method of wireless communication by a device. In some examples, the method includes sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication. In some examples, the method includes transmitting one of a data signal or a reservation signal over the one or more unassigned resources of the plurality of resources when the frequency band is sensed as idle.

Certain aspects relate to a method of wireless communication by a user equipment (UE). In some examples, the method includes receiving a signal indicating a presence of a wireless communication device. In some examples, the method includes transmitting a request for one or more resources of a frequency band for performing sidelink communication in response to receiving the signal. In some examples, the method includes receiving an indication of one or more assigned resources of the frequency band from the wireless communication device in response to the request.

Certain aspects relate to a wireless communication device. In some examples, the wireless communication device includes means for sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication. In some examples, the wireless communication device includes means for transmitting one of a data signal or a reservation signal over the one or more unassigned resources of the plurality of resources when the frequency band is sensed as idle.

Certain aspects relate to a user equipment (UE). In some examples, the UE includes means for receiving a signal indicating a presence of a wireless communication device. In some examples, the UE includes means for transmitting a request for one or more resources of a frequency band for performing sidelink communication in response to receiving the signal. In some examples, the UE includes means for receiving an indication of one or more assigned resources of the frequency band from the wireless communication device in response to the request.

Certain aspects relate to a non-transitory computer-readable medium having instructions stored thereon that, when executed by a wireless communication device, cause the wireless communication device to perform operations. In some examples, the operations include sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication. In some examples, the operations include transmitting one of a data signal or a reservation signal over the one or more unassigned resources of the plurality of resources when the frequency band is sensed as idle.

Certain aspects relate to a non-transitory computer-readable medium having instructions stored thereon that, when executed by a user equipment (UE), cause the UE to perform operations of wireless communication. In some examples, the operations include receiving a signal indicating a presence of a wireless communication device. In some examples, the operations include transmitting a request for one or more resources of a frequency band for performing sidelink communication in response to receiving the signal. In some examples, the operations include receiving an indication of one or more assigned resources of the frequency band from the wireless communication device in response to the request.

Certain aspects of the subject matter described in this disclosure can be implemented in a method for wireless communication by a device. The method generally includes measuring, prior to a time window, a frequency band to determine whether the frequency band is idle. In some examples, the method includes assigning one or more resources of a plurality of resources of the frequency band within the time window to one or more wireless communication devices in response to determining that the frequency band is idle, each of the plurality of resources of the frequency band within the time window comprising a corresponding period of time within the time window, the plurality of resources spanning the entire time window, each of the assigned one or more resources being for use by a corresponding wireless communication device to transmit one or more of a data signal or a reservation signal. In some examples, the method includes, when there are one or more remaining resources of the plurality of resources other than the one or more resources, transmitting one or more of a data signal or a reservation signal on the one or more remaining resources.

Certain aspects of the subject matter described in this disclosure can be implemented by a device configured for wireless communication. The device generally includes a processor, and a memory coupled to the processor. In some examples, the processor and the memory may be configured to measure, prior to a time window, a frequency band to determine whether the frequency band is idle. In some examples, the memory and processor are configured to assign one or more resources of a plurality of resources of the frequency band within the time window to one or more wireless communication devices in response to determining that the frequency band is idle, each of the plurality of resources of the frequency band within the time window comprising a corresponding period of time within the time window, the plurality of resources spanning the entire time window, each of the assigned one or more resources being for use by a corresponding wireless communication device to transmit one or more of a data signal or a reservation signal. In some examples, the memory and processor are configured to, when there are one or more remaining resources of the plurality of resources other than the one or more resources, transmit one or more of a data signal or a reservation signal on the one or more remaining resources.

Certain aspects of the subject matter described in this disclosure can be implemented in an apparatus configured for wireless communication. In some examples, the apparatus may include means for measuring, prior to a time window, a frequency band to determine whether the frequency band is idle. In some examples, the apparatus may include means for assigning one or more resources of a plurality of resources of the frequency band within the time window to one or more wireless communication devices in response to determining that the frequency band is idle, each of the plurality of resources of the frequency band within the time window comprising a corresponding period of time within the time window, the plurality of resources spanning the entire time window, each of the assigned one or more resources being for use by a corresponding wireless communication device to transmit one or more of a data signal or a reservation signal. In some examples, the apparatus may include means for, when there are one or more remaining resources of the plurality of resources other than the one or more resources, transmitting one or more of a data signal or a reservation signal on the one or more remaining resources.

Certain aspects of the subject matter described in this disclosure can be implemented in non-transitory computer-readable storage medium having instructions stored thereon for performing a method of wireless communication. In some examples, the method includes measuring, prior to a time window, a frequency band to determine whether the frequency band is idle. In some examples, the method includes assigning one or more resources of a plurality of resources of the frequency band within the time window to one or more wireless communication devices in response to determining that the frequency band is idle, each of the plurality of resources of the frequency band within the time window comprising a corresponding period of time within the time window, the plurality of resources spanning the entire time window, each of the assigned one or more resources being for use by a corresponding wireless communication device to transmit one or more of a data signal or a reservation signal. In some examples, the method includes, when there are one or more remaining resources of the plurality of resources other than the one or more resources, transmitting one or more of a data signal or a reservation signal on the one or more remaining resources.

Certain aspects of the subject matter described in this disclosure can be implemented in a method for wireless communication by a device. The method generally includes receiving a signal indicating a presence of a device. In some examples, the method includes transmitting a request for one or more resources in an unlicensed frequency band in response to the signal indicating the presence of the device. In some examples, the method includes receiving an indication of assigned one or more resources in the unlicensed frequency band from the device, the assigned one or more resources based on the request for one or more resources.

Certain aspects of the subject matter described in this disclosure can be implemented by a device configured for wireless communication. The device generally includes a processor, and a memory coupled to the processor. In some examples, the processor and the memory may be configured to receive a signal indicating a presence of a device. In some examples, the processor and memory may be configured to transmit a request for one or more resources in an unlicensed frequency band in response to the signal indicating the presence of the device. In some examples, the processor and memory may be configured to receive an indication of assigned one or more resources in the unlicensed frequency band from the device, the assigned one or more resources based on the request for one or more resources.

Certain aspects of the subject matter described in this disclosure can be implemented in an apparatus configured for wireless communication. In some examples, the apparatus may include means for receiving a signal indicating a presence of a device. In some examples, the apparatus may include means for transmitting a request for one or more resources in an unlicensed frequency band in response to the signal indicating the presence of the device. In some examples, the apparatus may include means for receiving an indication of assigned one or more resources in the unlicensed frequency band from the device, the assigned one or more resources based on the request for one or more resources.

Certain aspects of the subject matter described in this disclosure can be implemented in non-transitory computer-readable storage medium having instructions stored thereon for performing a method of wireless communication. In some examples, the method includes receiving a signal indicating a presence of a device. In some examples, the method includes transmitting a request for one or more resources in an unlicensed frequency band in response to the signal indicating the presence of the device. In some examples, the method includes receiving an indication of assigned one or more resources in the unlicensed frequency band from the device, the assigned one or more resources based on the request for one or more resources.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example base station (BS) and user equipment (UE), in accordance with certain aspects of the present disclosure.

FIG. 3 is a diagram conceptually illustrating an example of a first UE communicating with one or more other UEs according to aspects of the present disclosure.

FIG. 4 is a diagram illustrating an example frame format, in accordance with certain aspects of the present disclosure.

FIG. 5 is a signal diagram illustrating a series of examples in which a cellular vehicle-to-everything (CV2X) device successfully completes a listen-before-talk (LBT) procedure, in accordance with certain aspects of the present disclosure.

FIG. 6 is a schematic diagram illustrating an example model of multiple CV2X devices operating in an unlicensed spectrum and/or licensed spectrum, in accordance with certain aspects of the present disclosure.

FIG. 7 is a signal diagram illustrating an example model of communication over a frequency band of an unlicensed spectrum.

FIG. 8 is a signal diagram illustrating an example model of communication over a frequency band of an unlicensed spectrum, in accordance with certain aspects of the present disclosure.

FIG. 9 is a signal diagram illustrating an example model of communication over a frequency band of an unlicensed spectrum, in accordance with certain aspects of the present disclosure.

FIG. 10 is a signal diagram illustrating an example model of communication over a frequency band of an unlicensed spectrum, in accordance with certain aspects of the present disclosure.

FIG. 11 is a flow diagram illustrating example operations for wireless communication, in accordance with certain aspects of the present disclosure.

FIG. 12 is a flow diagram illustrating example operations for wireless communication, in accordance with certain aspects of the present disclosure.

FIG. 13 illustrates a communications device that may include various components configured to perform operations for the techniques disclosed herein in accordance with aspects of the present disclosure.

FIG. 14 illustrates a communications device that may include various components configured to perform operations for the techniques disclosed herein in accordance with aspects of the present disclosure.

FIG. 15 is a flow diagram illustrating example operations for wireless communication, in accordance with certain aspects of the present disclosure.

FIG. 16 is a flow diagram illustrating example operations for wireless communication, in accordance with certain aspects of the present disclosure.

FIG. 17 illustrates a communications device that may include various components configured to perform operations for the techniques disclosed herein in accordance with aspects of the present disclosure.

FIG. 18 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for controlling and scheduling communication between wireless communication devices (e.g., user equipment, base station, road side units, etc.). In certain aspects, the techniques described are applicable to wireless communication devices operating in an unlicensed spectrum, or in both a licensed and unlicensed spectrum. In certain aspects, the techniques described are applicable to wireless communication devices communicating via sidelink, such as in cellular vehicle to everything (CV2X) networks. It should be noted that though certain aspects are described with respect to sidelink communications in a licensed and/or unlicensed spectrum, such aspects may be applicable in other suitable wireless communication networks and/or scenarios.

In certain aspects, the following disclosure is directed to techniques for centrally reserving a time window (e.g., a time period) for communication by a supervisor device (e.g., a single wireless communication device, such as a BS, UE, road side unit, etc.), and assigning resources of a frequency band (e.g., of an unlicensed spectrum) within that time window to one or more wireless communication devices, including one or more other wireless communication devices than the supervisor device. In certain aspects, the supervisor device may further assign resources of the frequency band to itself. The resources of the frequency band within the time window may include time-frequency resources, such as resource elements (REs), symbols, slots, etc. In certain aspects, the reserving may be referred to as being performed “centrally” in that in certain aspects a single supervisor device may coordinate the reserving on behalf of the one or more wireless communication devices. It should be noted, however, in certain aspects, the supervisor device may change for different time windows. In certain aspects, before the supervisor device can assign resources to the one or more other wireless communication devices, it may determine the number of wireless communication devices within range, and the resource needs of each wireless communication device.

Thus, in some examples, the supervisor device may be configured to transmit a signal indicating its presence to one or more (e.g., any) other wireless communication devices in range. In certain aspects, within “range” means any other wireless communication devices that are able to successfully receive and decode the signal transmitted by the supervisor device. In some examples, the signal indicating presence may be broadcast over a licensed band (e.g., a band used in a long term evolution (LTE) system). Any wireless communication devices in range of the supervisor device may, in response to the signal, transmit an indication of the corresponding wireless communication device's resource requirements to the supervisor device. The resource requirements may indicate, for example, a number of time-frequency resources that wireless communication device needs to transmit data, an amount of data that wireless communication device has to transmit, etc. In some examples, the response is transmitted over a licensed band.

The supervisor device may then perform a listen-before-talk (LBT) channel sensing procedure on the unlicensed frequency band to determine whether the unlicensed frequency band is idle or busy. In an LBT channel sensing procedure, a device (e.g., the supervisor device) measures energy on the frequency band and refrains from transmitting on the frequency band should the frequency band be busy, and determines it may communicate on the frequency band should the frequency band be idle. As used herein, the term “idle” for a frequency band means that energy as measured on the frequency band by a device (e.g., the supervisor device) determining idleness is below a threshold level. As used herein, the term “busy” for a frequency band means that energy as measured on the frequency band by the device determining idleness is above the threshold level. Such energy may be due to noise or signals within the frequency band.

If the unlicensed frequency band is idle, the supervisor device may initiate the time window by transmitting initiation signaling over the unlicensed frequency band. In some examples, the initiation signaling may provide each of the one or more other wireless communication devices with an indication of the resources assigned to them. Because the supervisor device performs the LBT procedure and schedules resources for communications on the unlicensed frequency band, the supervisor device may initiate time window reservation for other wireless communication devices to communicate even if the supervisor device has no data to transmit or receive. In some examples, the supervisor device initiates time window reservation periodically based on either a pattern (e.g., a recurring pattern of time windows) or adaptively (e.g., based on an amount of traffic over the frequency band). For instance, if the frequency band has a relatively low amount of traffic, or signaling from non-CV2X devices, the supervisor device may only initiate time window reservation according to a consistent, recurring pattern of time windows. However, if the frequency band has a relatively high amount of traffic (e.g., is a crowded band), the supervisor device may attempt to initiate the time window reservation more frequently to ensure that the other wireless communication devices have an opportunity to communicate.

In certain aspects, the supervisor device may schedule the wireless communication devices so that all transmissions by the wireless communication devices occur within a first portion of the time window (e.g., a continuous portion having no gaps). That is, the supervisor device front loads the time window with all the wireless communication devices transmissions so that all the transmissions occur at the start of the time window. In this example, any remaining time window duration after the transmissions may not be reserved and may be available for communication, such as by other devices (e.g., non-CV2X devices). In certain aspects, the supervisor device may distribute wireless communication devices transmissions throughout the entire time window, and transmit reservation signals over slots that will not be used for transmissions. In this way, the supervisor device maintains the entire duration of the time window by filling any the gaps in the time window with reservation signals

Techniques discussed herein allow for (e.g., cellular vehicle-to-everything (CV2X)) devices to communicate in an unlicensed band without causing interference to other devices operating in the same unlicensed band by using a supervisor device to control communications between a pluralities of devices during a reserved window of time, thereby enhancing device coexistence.

Accordingly, the techniques herein lead to improved reliability and accessibility of communications in unlicensed spectrum, by centrally controlling communication timing between devices. Thus, these techniques can help improve latency, by reducing the time devices have to wait to communicate over the unlicensed band. These techniques can further improve data decoding reliability, by allowing devices to communicate during common time windows, and thus be able to decode transmissions during the common time windows.

Such techniques may be used, for example, in sidelink communications between wireless communication devices. In other examples, the wireless communication devices may include vehicle-to-everything (V2X) and/or CV2X devices. It should be noted that though certain aspects are described with respect to CV2X devices and communication in the unlicensed band, it can be appreciated that the aspects may similarly be applicable to other scenarios, such as any communications (e.g., sidelink communications) in an unlicensed band, communications (e.g., sidelink communications) in a licensed band, etc.

An unlicensed band refers to any frequency band(s) that are not subject to licensed use under regulatory practice, such that they are open to use by any devices, and not just devices that have a license to use the particular frequency band(s).

The electromagnetic spectrum is often subdivided, based on frequency/wavelength, into various classes, bands, channels, etc. In 5G NR two initial operating bands have been identified as frequency range designations FR1 (410 megahertz (MHz)-7.125 gigahertz (GHz)) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the international telecommunications union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The following description provides examples of techniques for centrally scheduling wireless communication between wireless communication devices, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. In licensed bands, each frequency may support a single RAT in a given geographic area in order to avoid interference between wireless networks of different RATs. However, in unlicensed bands, each frequency may support any number of RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

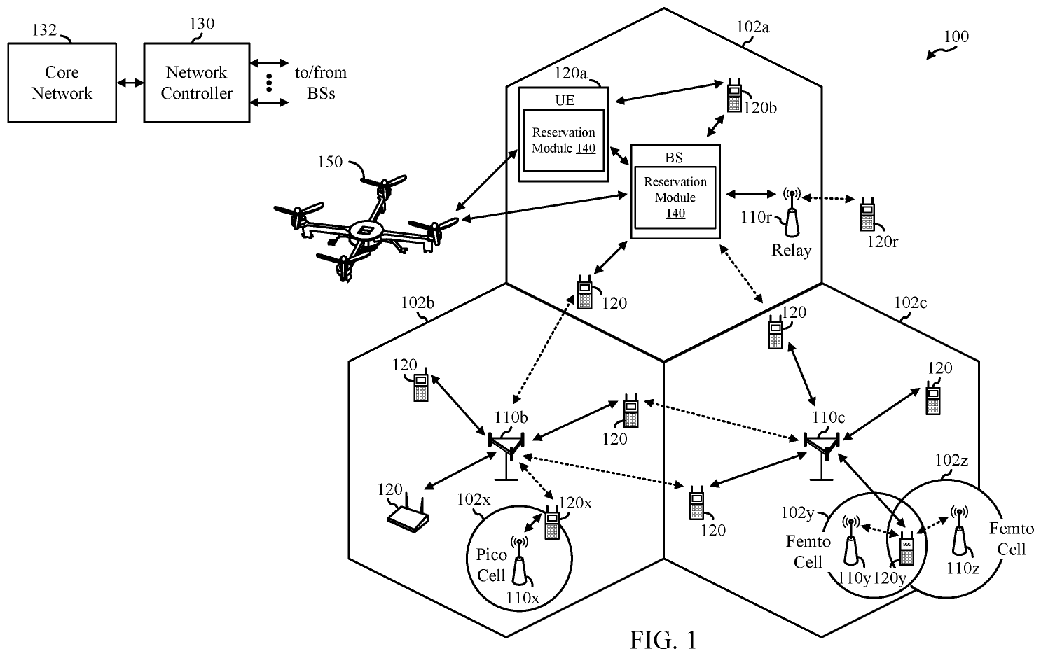

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. A network controller 130 may couple to a set of BSs 110 and provide coordination and control for these BSs 110 (e.g., via a backhaul).

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

FIG. 1 also includes a quadcopter, drone, or any other unmanned aerial vehicle (UAV) or remotely piloted aerial system (RPAS) 150, which may be configured to function as either a BS or UE, or may incorporate functional aspects of both. That is, in some examples, the RPAS 150 may functionally operate as a UE or BS, but may also function as a supervisor device configured to control communications and scheduling over an unlicensed band.

In some examples of the wireless communication network 100, sidelink communication may be established between UEs and/or BSs without necessarily relying on UE ID or control information from a base station. For example, UE 120a may initiate a sidelink communication with UE 120b without relying on a direct connection with a base station (e.g., base station 110a), such as if the UE 120b is outside of cell 102a's range. Any of the UEs illustrated in FIG. 1 may function as a scheduling entity or a primary sidelink device (e.g., “supervisor device”), while the other UEs may function as a subordinate entity or a non-primary (e.g., secondary) sidelink device. Further, the UEs may be configured to transmit synchronization signaling for sidelink as described throughout the disclosure. Accordingly, one or more of the UEs may function as a scheduling entity in a device-to-device (D2D), peer-to-peer (P2P), or vehicle-to-vehicle (V2V) network, and/or in a mesh network to initiate and/or schedule synchronization signaling. It should be noted that although the above examples relate to a UE functioning as the supervisor device in terms of sidelink scheduling, a BS may also be configured for scheduling resources (e.g., assignment of resources and reservation of time windows) for sidelink communication in an unlicensed band.

According to certain aspects, the BSs 110 and/or UEs 120 may be configured for scheduling resources and managing communications over a wireless interface, such as in one or more unlicensed frequency bands. As shown in FIG. 1, one or more of the UE 120a and the BS 110a include a reservation module 140. The reservation module 140 may be configured to measure, prior to a time window, a frequency band to determine whether the frequency band is idle. The reservation module 140 may also be configured to assign one or more resources of a plurality of resources of the frequency band within the time window to one or more wireless communication devices in response to determining that the frequency band is idle. In some examples, the reservation module 140 may be configured to transmit one or more of a reservation signal or a data signal on one or more remaining resources when there are one or more remaining resources of the plurality of resources other than the one or more resources.

The reservation module 140 may also be configured to transmit, prior to the time window, a signal indicating a presence of the UE 120a or BS 110a, and receive, in response to the signal, one or more requests from the one or more wireless communication devices indicating an amount of resources.

In certain aspects, the reservation module 140 may be configured to perform reciprocating functions to those described above. For example, the reservation module 140 may receive the signal indicating a presence of a device, and transmit the request for one or more resources in an unlicensed frequency band in response to the signal indicating the presence of the device. In some examples, the reservation module 140 may receive an indication of assigned one or more resources in the unlicensed frequency band from the device, the assigned one or more resources based on the request for one or more resources.

In certain aspects, the reservation module 140 may be configured to sense, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication. The reservation module 140 may also transmit one of a data signal or a reservation signal over the one or more unassigned resources of the plurality of resources when the frequency band is sensed as idle.

In certain aspects, the reservation module 140 may be configured to receive a signal indicating a presence of a wireless communication device. The reservation module 140 may also transmit a request for one or more resources of a frequency band for performing sidelink communication in response to receiving the signal. The reservation module 140 may also receive an indication of one or more assigned resources of the frequency band from the wireless communication device, in response to the request.

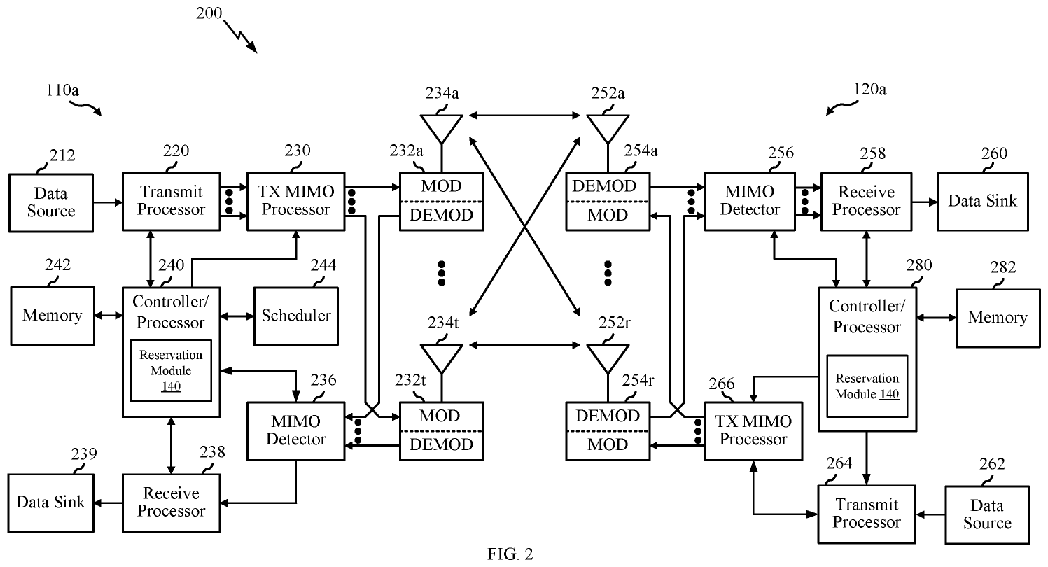

FIG. 2 illustrates example components 200 of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid automatic repeat request (HARD) indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the processor 240 of the BS 110a and the processor 280 of the UE 120a have a reservation module 140 that may be configured to schedule resources and manage communications over a wireless interface, such as in one or more unlicensed frequency bands. The reservation module 140 may be configured to measure, prior to a time window, a frequency band to determine whether the frequency band is idle. The reservation module 140 may also be configured to assign one or more resources of a plurality of resources of the frequency band within the time window to one or more wireless communication devices in response to determining that the frequency band is idle. In some examples, the reservation module 140 may be configured to transmit one or more of a reservation signal or a data signal on one or more remaining resources when there are one or more remaining resources of the plurality of resources other than the one or more resources.

The reservation module 140 may also be configured to transmit, prior to the time window, a signal indicating a presence of the UE 120a or BS 110a, and receive, in response to the signal, one or more requests from the one or more wireless communication devices indicating an amount of resources.

In certain aspects, the reservation module 140 may be configured to perform reciprocating functions to those described above. For example, the reservation module 140 may receive the signal indicating a presence of a device, and transmit the request for one or more resources in an unlicensed frequency band in response to the signal indicating the presence of the device. In some examples, the reservation module 140 may receive an indication of assigned one or more resources in the unlicensed frequency band from the device, the assigned one or more resources based on the request for one or more resources.

In certain aspects, the reservation module 140 may be configured to sense, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication. The reservation module 140 may also transmit one of a data signal or a reservation signal over the one or more unassigned resources of the plurality of resources when the frequency band is sensed as idle.

In certain aspects, the reservation module 140 may be configured to receive a signal indicating a presence of a wireless communication device. The reservation module 140 may also transmit a request for one or more resources of a frequency band for performing sidelink communication in response to receiving the signal. The reservation module 140 may also receive an indication of one or more assigned resources of the frequency band from the wireless communication device, in response to the request.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 kilohertz (kHz) and other SCS may be defined with respect to the base SCS (e.g., 30 kHz, 60 kHz, 120 kHz, 240 kHz, etc.).

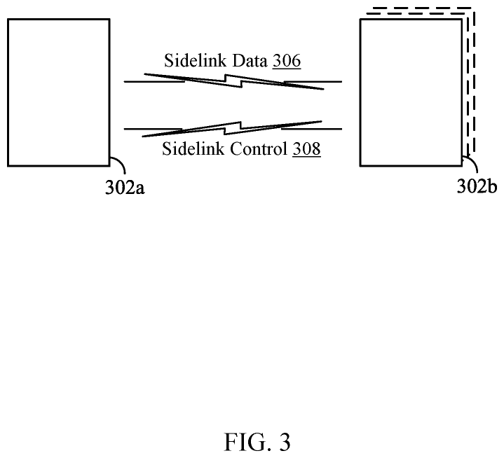

FIG. 3 is a diagram conceptually illustrating a sidelink communication between a wireless communication device 302a and one or more UEs 302b (e.g., UEs 120a of FIG. 1) or other suitable node in the wireless communication network 100. The wireless communication device 302a may correspond to any one of a BS 110 (e.g., BS 110a of FIG. 1) of UE 120 (e.g., UE 120a of FIG. 1) or other suitable node in the wireless communication network 100.

In some examples, the wireless communication device 302a and the one or more UEs 302b may utilize sidelink signals for direct D2D communication. The D2D communication may use the downlink/uplink wireless wide area network (WWAN) spectrum and/or an unlicensed spectrum. The D2D communication may use one or more sidelink channels, such as a physical sidelink broadcast channel (PSBCH), a physical sidelink discovery channel (PSDCH), a physical sidelink shared channel (PSSCH), and a physical sidelink control channel (PSCCH) over these spectrums. D2D communication may be through a variety of wireless D2D communications systems, such as for example, FlashLinQ, WiMedia, Bluetooth, ZigBee, Wi-Fi based on the institute of electrical and electronic engineers (IEEE) 802.11 standard, LTE, or NR.

Sidelink signals may include sidelink data 306 (i.e., sidelink traffic) and sidelink control information 308. Broadly, the wireless communication device 302a and the one or more UEs 302b may communicate sidelink data 306 and sidelink control information 308 using one or more data channels and control channels. In some aspects, data channels include the PSSCH, and control channels include the PSCCH and/or physical sidelink feedback channel (PSFCH).

Sidelink control information 308 may include a source transmit signal (STS), a direction selection signal (DSS), and a destination receive signal (DRS). The DSS/STS may provide the one or more UEs 302b and wireless communication device 302a a means to request a duration of time to keep a sidelink channel available for a sidelink signal; and the DRS may provide for the devices to indicate the availability of the sidelink channel, e.g., for a requested duration of time. Accordingly, the wireless communication device 302a and the one or more UEs 302b may negotiate the availability and use of sidelink channel resources prior to communication of sidelink data 306 information.

In some configurations, any one or more of the wireless communication device 302a or the one or more UEs 302b may periodically/aperiodically transmit or broadcast sidelink synchronization signaling to increase chances of detection by another UE or BS. For example, one or more of the wireless communication device 302a and the one or more UEs 302b may periodically/aperiodically transmit sidelink synchronization signals in one or more slots of specific time windows. In some examples, the UEs are preconfigured with information indicating the location and duration of the time window within a frame (e.g., which slots within the frame, and how many). In some aspects, the devices may be configured with the location and duration of the time window via messaging between UEs or messaging received from a BS (e.g., radio resource control (RRC) signaling).

The channels or carriers illustrated in FIG. 3 are not necessarily all of the channels or carriers that may be utilized between the wireless communication device 302a and the one or more UEs 302b in a sidelink communication, and those of ordinary skill in the art will recognize that other channels or carriers may be utilized in addition to those illustrated, such as other data, control, and feedback channels.

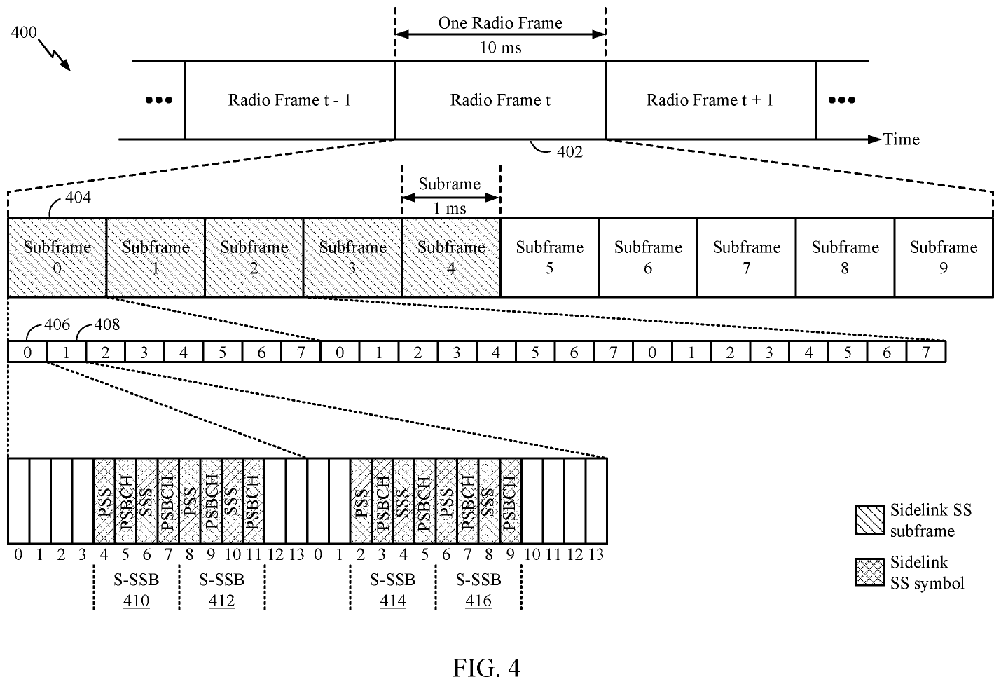

FIG. 4 is a diagram showing an example of a frame format 400. The transmission timeline for each data transmission and reception may be partitioned into units of radio frames 402. In NR, the basic transmission time interval (TTI) may be referred to as a slot. In NR, a subframe may contain a variable number of slots (e.g., 1, 2, 4, 8, 16, . . . , N slots) depending on the subcarrier spacing (SCS). NR may support a base SCS of 15 KHz and other SCS may be defined with respect to the base SCS (e.g., 30 kHz, 60 kHz, 120 kHz, 240 kHz, etc.). In the example shown in FIG. 4, the SCS is 120 kHz. As shown in FIG. 4, the subframe 404 (subframe 0) contains 8 slots (slots 0, 1, . . . , 7) with a 0.125 ms duration. The symbol and slot lengths scale with the subcarrier spacing. Each slot may include a variable number of symbol (e.g., OFDM symbols) periods (e.g., 7 or 14 symbols) depending on the SCS. For the 120 kHz SCS shown in FIG. 4, each of the slot 406 (slot 0) and slot 408 (slot 1) includes 14 symbol periods (slots with indices 0, 1, . . . , 13) with a 0.25 ms duration.

In sidelink, a sidelink synchronization signal block (S-SSB), referred to as the SS block or SSB, is transmitted. The SSB may include a primary SS (PSS), a secondary SS (SSS), and/or a two symbol physical sidelink broadcast channel (PSBCH). In some examples, the SSB can be transmitted up to sixty-four times with up to sixty-four different beam directions. The up to sixty-four transmissions of the SSB are referred to as the SS burst set. SSBs in an SS burst set may be transmitted in the same frequency region, while SSBs in different SS bursts sets can be transmitted in different frequency regions.

In the example shown in FIG. 4, in the subframe 404, SSB is transmitted in each of the slots (slots 0, 1, . . . , 7). In the example shown in FIG. 4, in the slot 406 (slot 0), an SSB 410 is transmitted in the symbols 4, 5, 6, 7 and an SSB 412 is transmitted in the symbols 8, 9, 10, 11, and in the slot 408 (slot 1), an SSB 414 is transmitted in the symbols 2, 3, 4, 5 and an SSB 416 is transmitted in the symbols 6, 7, 8, 9, and so on. The SSB may include a primary SS (PSS), a secondary (SSS), and a two symbol physical sidelink broadcast channel (PSBCH). The PSS and SSS may be used by UEs to establish sidelink communication (e.g., transmission and/or reception of data and/or control channels). The PSS may provide half-frame timing, the SS may provide cyclic prefix (CP) length and frame timing. The PSBCH carries some basic system information, such as system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), and other system information (OSI) can be transmitted on a physical sidelink shared channel (PSSCH) in certain subframes.

### Example Techniques for Reserving Time Windows in Unlicensed Bands

Aspects of the present disclosure provide for implementing frame-based communication techniques to support CV2X communications such as in an unlicensed spectrum. In one example, CV2X devices are configured for periodic intervals of communication, where partitions of time (also referred to as a time window or channel occupancy time (COT)) are periodically reserved for CV2X communications. The interval of time may be referred to as a COT, as it is the duration of time the unlicensed frequency band is “occupied” or used by one or more CV2X devices, and thus is unavailable for use by non-CV2X devices. In this example, CV2X devices may communicate within the time windows over the unlicensed spectrum, and refrain from communicating outside of the time windows to allow other wireless communication devices an opportunity to transmit and receive data. Within the time windows, the CV2X devices may communicate using aspects of the same frame format used in a licensed spectrum. For example, CV2X devices may partition the time window into slots as illustrated in FIG. 4.

In certain aspects, the duration of the time windows may depend, among other things, geographic considerations including use of the unlicensed spectrum in the area. For example, if a particular area has a relatively high amount of non-CV2X wireless communication traffic over the unlicensed spectrum, the time windows for CV2X communications may be reduced in time duration and/or periodicity (e.g., a duration of time between occurrence of a first time window and a second time window is increased, making time windows less frequent) to maintain availability of the unlicensed spectrum for use by non-CV2X devices. In another example, if a particular area has a relatively high number of CV2X devices, and/or a relatively high amount of wireless communication between the CV2X devices, time windows for CV2X communication may be increased in time duration and/or periodicity (e.g., a duration of time between occurrence of a first time window and a second time window is decreased, making time windows more frequent), and the non-CV2X windows may be decreased in time duration.

In certain aspects, non-CV2X devices are not designed for operations such as reservation of time windows and frame-based communications. Thus, the CV2X devices may be configured to impose such operations on the non-CV2X devices. In certain aspects, the imposition of such operations by the CV2X devices may include a listen-before-talk (LBT) procedure. For example, in certain aspects, regulatory-imposed rules for unlicensed spectrum operation restrict accessing the unlicensed frequency band when it is sensed busy.

For example, one or more CV2X devices may perform the LBT procedure prior to a scheduled or configured time window to determine whether a frequency band in the unlicensed spectrum is idle prior to communicating over the frequency band. If the one or more CV2X devices sense the frequency band idle, one or more of the CV2X devices may (e.g., immediately, meaning without a gap in time after performance of the LBT procedure) begin transmitting over at least part of the frequency band to reserve it. The transmission by the one or more CV2X devices may be sensed by non-CV2X devices, which may cause the non-CV2X devices to refrain from communicating over the frequency band as they may determine the frequency band is busy when performing an LBT procedure. Thus, with non-CV2X devices refraining from transmission due to CV2X device transmissions within the time window, CV2X devices may transmit without any interference from the non-CV2X devices, such as up to the maximum duration of the time window. It should be noted that the transmissions within a time window may be continuous (e.g., there is no gap in transmission); otherwise, a non-CV2X device may detect the frequency band as idle within the time window, and begin transmitting. In addition, in certain aspects (e.g., by regulation), whenever a transmission stops, the channel may be sensed again before proceeding with the next transmission. Therefore, any gap in transmission may mean that an LBT procedure needs to be performed again before a second transmission can be performed again, even if the second transmission is within the maximum duration of the time window starting from the start of the initial transmission.

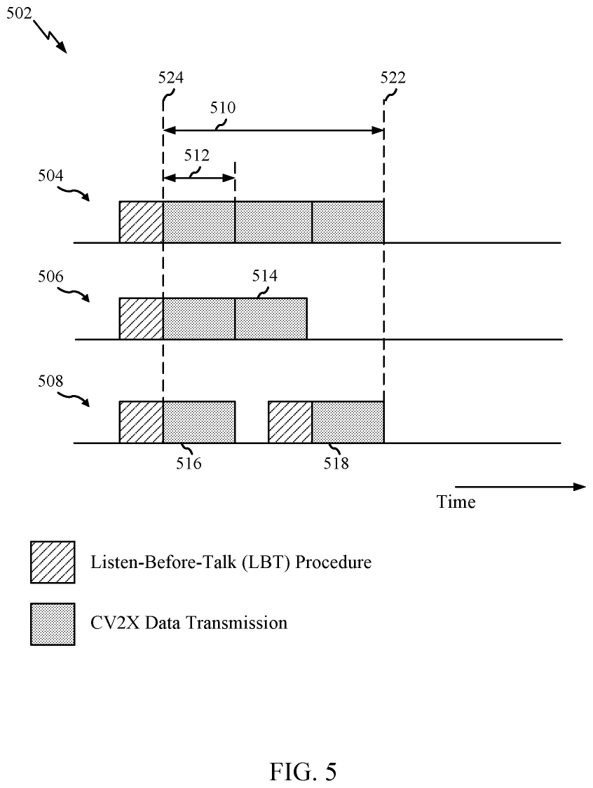

FIG. 5 is a signal diagram 502 illustrating three example communications (e.g., a first example communication 504, a second example communication 506, and a third example communication 508) in which a CV2X device (e.g., UE 120a of FIG. 1) successfully completes an LBT procedure. Each example 504-508 is a separate example of how a CV2X device may communicate, and is not necessarily indicative of simultaneous communication by multiple CV2X devices. In each of these examples, the CV2X device performs the LBT procedure (e.g., immediately) prior to a channel occupancy time (COT) (e.g., “time window”) to establish communication over a frequency band in an unlicensed spectrum. In this diagram, time is indicated on an x-axis. The three examples shown are illustrative of the continuous transmission requirement within the time window. As discussed, and further explained hereafter, gaps in transmission may effectively release the time window prior to the maximum duration of the time window, causing a CV2X device 120a to perform additional LBT procedures to reserve the remaining duration of the time window for CV2X communication.

Initially, transmission over the frequency band is preceded by a time interval over which the frequency band is sensed as idle. During the time interval, the CV2X device 120a performs an LBT procedure (e.g., 25 us duration). In some examples, the LBT procedure is performed during a distributed coordination function (DCF) intra-frame space (DIFS) period. In particular, such a DIFS period may not be assigned for other communication by a CV2X device, and therefore may be available for use by the CV2X device to perform LBT.

In the first example communication 504, a CV2X device 120a performs an LBT procedure prior to a time window 510 (as illustrated, the time window is made up of 3 slots 512 for all three examples; however, time windows of any other suitable duration are contemplated). Here, it is assumed no local interference (e.g., signaling from non-CV2X devices) is sensed during the LBT procedure, so the CV2X device 120a is able to (e.g., immediately) begin transmitting CV2X data at the start 524 of the time window 510. Here, the CV2X device transmits data in a slot 512 format, and utilizes each slot 512 within the time window 510. Upon expiration 522 of the time window 510, the CV2X device 120a stops transmitting to provide non-CV2X devices with an opportunity to communicate.

In the second example communication 506, the CV2X device 120a performs an LBT procedure prior to the time window 510. Here, it is assumed no local interference is sensed during the LBT procedure, so the CV2X device 120a is able to (e.g., immediately) begin transmitting CV2X data at the start 524 of the time window 510. In this case, the CV2X device 120a stops transmitting data after the second slot 514 such as, for example, if the CV2X device 120a has no additional data to transmit, effectively not reserving the remaining duration of the time window 510. It should be noted that, in certain aspects, if the CV2X device 120a does not transmit over the first slot at the start of the time window 510, the CV2X device 120a may not reserve the entire duration of the time window 510. For example, a non-CV2X device may begin transmitting non-CV2X data over the frequency band after sensing that the frequency band is unoccupied, meaning not reserved, by CV2X transmissions. In such an example, with the non-CV2X device now occupying the frequency band with its own transmissions, the CV2X device 120a may have to wait until the frequency band is idle again to make any additional CV2X data transmissions.

In the third example communication 508, the CV2X device 120a performs an LBT procedure prior to the time window 510. Here, it is assumed no local interference is sensed during the LBT procedure, so the CV2X device 120a is able to (e.g., immediately) begin transmitting CV2X data at the start 524 of the time window 510. Here, the CV2X device 120a transmits data in the first slot 516 and a third slot 518 in the time window 510. However, because no data is transmitted during the second slot 514, the remaining duration (e.g., the second slot 514 and the third slot 518) of the time window 510 is not reserved after the first slot 516 transmission. Thus, in order to transmit over the third slot 518 of the time window 510, the CV2X device 120a may perform another LBT procedure (e.g., immediately) prior to the third slot 518 in order to transmit during the third slot 518. In this example, the CV2X device 120a does not sense any interference over the frequency band during the other LBT procedure.

Certain aspects herein provide techniques for centrally scheduling communications and reserving time windows on an unlicensed band. Such techniques may improve CV2X communications by providing continuous utilization of a time window by the CV2X devices. For example, such techniques allow multiple CV2X devices to be scheduled for communication within a time window centrally. In certain aspects, this allows for efficient use of the unlicensed frequency band, and may allow for a limited number of LBT procedures to be performed by the CV2X devices.

### Example Techniques for Centralized Channel Access

According to certain aspects, a single CV2X device 120a (e.g., “supervisor”) may perform an LBT procedure and reserve a time window for communication between the supervisor 120a and one or more other CV2X devices 120, and/or between multiple non-supervisory CV2X devices 120. In some examples, the supervisor 120a may include a UE (e.g., UE 120a of FIGS. 1 and 2) or a BS (e.g., BS 110a of FIGS. 1 and 2). The UE 120a may be mobile (e.g., phone, tablet, drone (e.g., drone 150 of FIG. 1) or other aerial vehicle, etc.) or non-mobile (e.g., roadside unit (RSU), etc.). Thus, in some examples, the supervisor may be stationary, or the geographic range of the supervisor may move according to the location of a mobile supervisor. In some examples, a stationary RSU may occupy a strategic location (e.g., street intersection) and reserve time windows for communication between CV2X devices 120 (e.g., CV2X devices such as vehicles located near the intersection).

In some examples, the supervisor 120a initiates a time window reservation by performing the LBT procedure. Here, supervisor 120a measures a frequency band for a period of time (e.g., immediately) prior to the time window to determine whether the frequency band is idle. Because the supervisor 120a performs the LBT procedure and schedules resources for CV2X communications, the supervisor 120a may initiate time window reservation for other CV2X devices 120 to communicate even if the supervisor 120a has no data to transmit or receive. In some examples, the supervisor 120a initiates time window reservation periodically based on either a (pre-) configured pattern (e.g., a recurring pattern of time windows) or adaptively (e.g., based on an amount of traffic over the frequency band). For instance, if the frequency band has a relatively low amount of traffic, or signaling from non-CV2X devices, the supervisor may only initiate time window reservation according to a consistent, recurring pattern of time windows. However, if the frequency band has a relatively high amount of traffic (e.g., is a crowded band), the supervisor 120a may attempt to initiate the time window reservation more frequently to ensure that the CV2X devices 120 have an opportunity to communicate.

The supervisor 120a may assign resources (e.g., time slots and/or frequency subchannels within the frequency band) within the time window to CV2X devices 120 within range of the supervisor 120a upon sensing that the frequency band is idle (e.g., available for CV2X communication during a time window). In certain aspects, within “range” may be those CV2X devices 120 for which the supervisor 120a receives and successfully decodes a request for resources in the unlicensed frequency band. For example, such CV2X devices 120 may be one or more of any CV2X devices 120 able to successfully receive and decode a signal from the supervisor 120a. In some examples, the supervisor 120a may assign resources prior to reserving the time window. In other examples, the supervisor 120a may assign resources after reserving the time window, as discussed further below regarding an “initiation signal.” Accordingly, scheduled CV2X devices 120 are able to operate on the resources assigned to them without having to perform an LBT procedure if the supervisor assigns resources to the CV2X devices 120 such that the time window is continuously utilized.

As discussed, the time window may not be reserved if no CV2X devices 120 transmit over a particular slot within the time window. Thus, in some examples, supervisor 120a is configured to schedule communications of the CV2X devices 120 by distributing the communications over the slots within the time window so that at least one CV2X device 120 or the supervisor 120a transmits over each slot within the time window. This provides a continuous transmission of CV2X signaling within the time window, and prevents non-CV2X devices from interfering.

In certain aspects, the supervisor 120a may control resource scheduling within the time window based on a number of CV2X devices 120 (and corresponding resource requirements) that will communicate within the time window. In certain aspects, if the network load is small (e.g., a relatively low number of CV2X devices, and/or the CV2X devices require relatively fewer slots during the time window), the supervisor may schedule communications accordingly. In certain aspects, the supervisor 120a may schedule the CV2X devices 120 so that all transmissions by the CV2X devices 120 occur within a first portion of the time window. That is, the supervisor 120a front loads the time window with all the CV2X device 120 transmissions so that all the transmissions occur at the start of the time window. In this example, any remaining time window duration after the transmissions may not be reserved and may be available for communication, such as by non-CV2X devices.

In certain aspects, the supervisor 120a may distribute CV2X device transmissions throughout the entire time window, and transmit reservation signals over slots that will not be used for CV2X device 120 transmissions. In this way, the supervisor 120a maintains the entire duration of the time window by filling any the gaps in the time window with reservation signals.

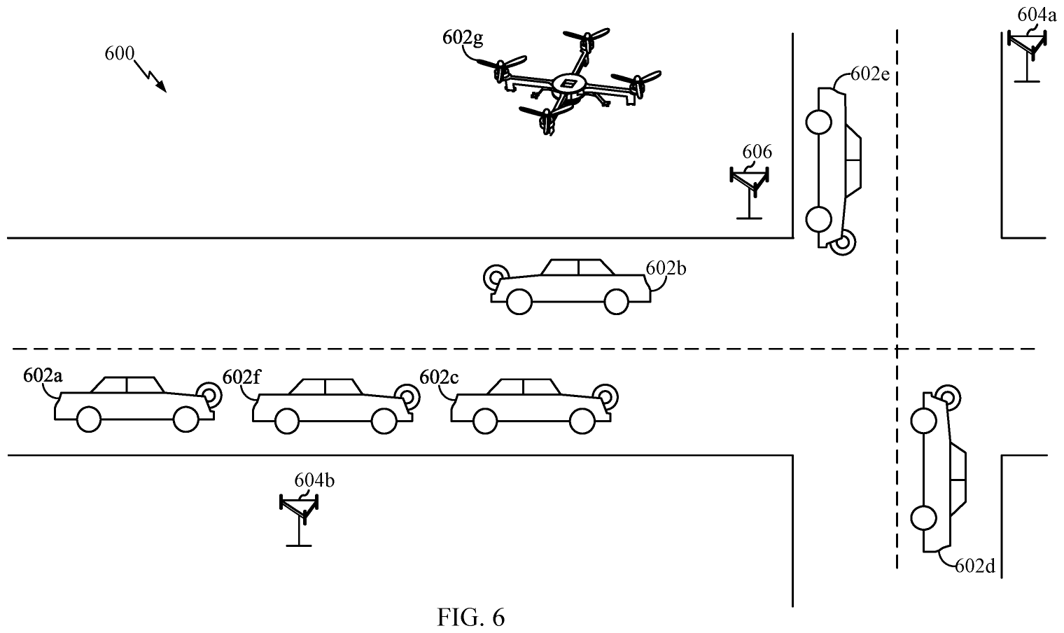

FIG. 6 is a schematic diagram illustrating an example network 600 of multiple CV2X devices operating in an unlicensed spectrum. In the illustrated example, seven CV2X devices (e.g., a first CV2X device 602a, a second CV2X device 602b, a third CV2X device 602c, a fourth CV2X device 602d, a fifth CV2X device 602e, a sixth CV2X device 602f, and a seventh CV2X device 602g)—collectively referred to as CV2X devices 602) may operate in an unlicensed spectrum with other non-CV2X devices (e.g., non-CV2X devices 604a and 604b—collectively referred to as non-CV2X devices 604). FIG. 6 also shows a wireless communication device that functions as a supervisor 606. In this example, the supervisor 606 is a roadside unit (RSU) configured to manage communications with CV2X devices 602 within range of it.

In some examples, the first CV2X device 602a, the sixth CV2X device 602f, and the third CV2X device 602c may be part of a fleet. Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 602 may include devices on motorcycles, or carried by users (e.g., pedestrian, bicyclist, etc.), and other environments may include indoor environments such as offices, residential, or urban infrastructure (e.g., subways, trains, etc.) environments. The CV2X devices 602 and/or supervisor 606 may also include UEs (e.g., UE 120 of FIG. 1) and/or RSUs operated by a highway authority, and may be devices implemented on motorcycles or carried by users (e.g., pedestrian, bicyclist, etc.), or may be implemented on another aerial vehicle such as a helicopter or drone.

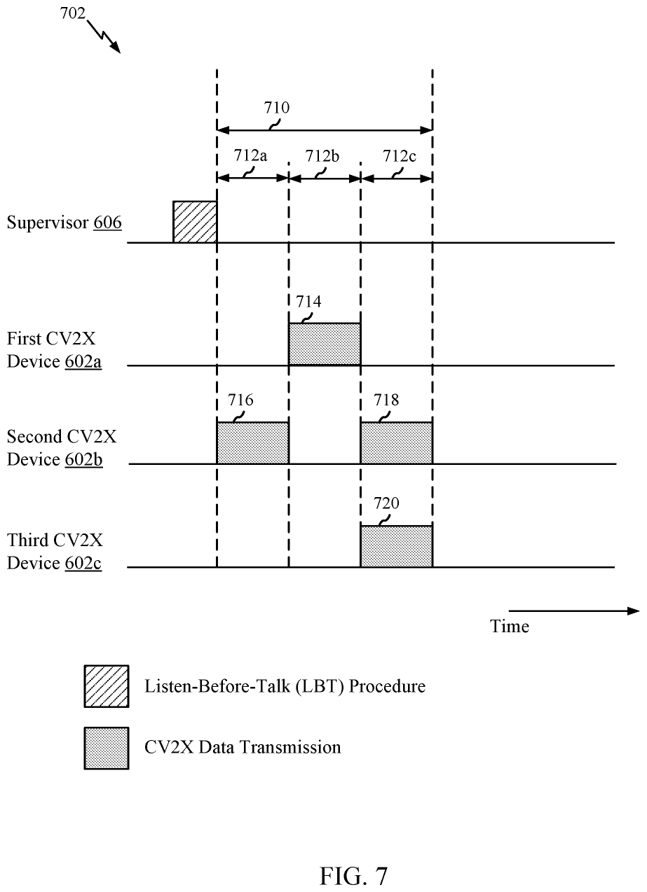

FIG. 7 is a signal diagram illustrating an example of communication 702 by the CV2X devices 602a-c and supervisor 606 of FIG. 6 over a frequency band of an unlicensed spectrum. In this diagram, a time dimension is indicated on an x-axis of the model.

In this example, the supervisor 606 initiates reservation of a time window 710 (e.g., COT) by first performing an LBT procedure prior to the time window 710 to sense whether the frequency band is idle (e.g., by measuring the frequency band). In response to a determination that the frequency band is idle, the supervisor 606 may assign one or more slots (e.g., a first slot 712a, a second slot 712b, and a third slot 712c, all of which make up the time window 710) in the frequency band within the time window 710 to one or more of the CV2X devices 602. In this example, the supervisor 606 has three slots 712 it can assign within the time window 710, with each of the three slots 712 having a corresponding period of time within the time window. It should be understood that time window 710 may have fewer or a greater number of slots, or other suitable time periods. The first CV2X device 602a has first data 714 to transmit during the second slot 712b, the second CV2X device 602b has second data 716 to transmit during the first slot 712a and third data 718 to transmit during the third slot 712c, and the third CV2X device 602c has fourth data 720 to transmit during the third slot 712c. Accordingly, the resources used by the CV2X devices 602 for transmission fully utilize the time resources of the time window 710 (e.g., no further LBT procedure needs to be performed within the time window 710).

Although not shown in FIG. 7, if there are one or more other slots in the time window other than the slots used by the CV2X devices 602 for transmission, the supervisor 606 may transmit one or more of a data signal or a reservation signal during the one or more other slots to reserve the time window 710.

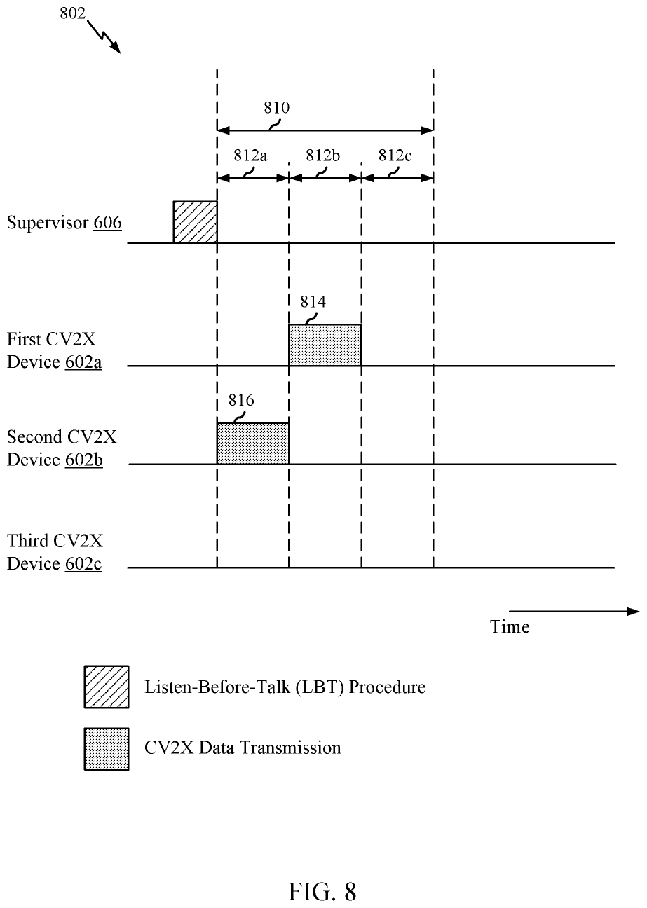

FIG. 8 is a signal diagram illustrating an example model of communication 802 by the CV2X devices 602 and supervisor 606 of FIG. 6 over a frequency band of an unlicensed spectrum. In this example, the supervisor 606 initiates reservation of a time window 810 (e.g., COT) by first performing an LBT procedure prior to the time window 810 to sense whether the frequency band is idle. Here, the time window 810 includes three slots 812 (e.g., a first slot 812a, a second slot 812b, and a third slot 812c), though it should be understood that time window 810 may have fewer or a greater number of slots, or other suitable time periods.

In response to a determination that the frequency band is idle, the supervisor 606 assigns the first slot 812a at the beginning of the time window 810 to the second CV2X device 602b to transmit first data 816, and assigns the second slot 812b in the middle of the time window 810 to the first CV2X device 602a to transmit second data 814. Here, the third CV2X device 602c does not have any data to transmit, and all the CV2X transmissions are scheduled at the front end of the time window 810, so the entire time window 810 is not used (e.g., no transmission are made over a third slot in the time window). Accordingly, the third slot in the time window 810 is not reserved, and may be used for communication by another device such as a non-CV2X device.

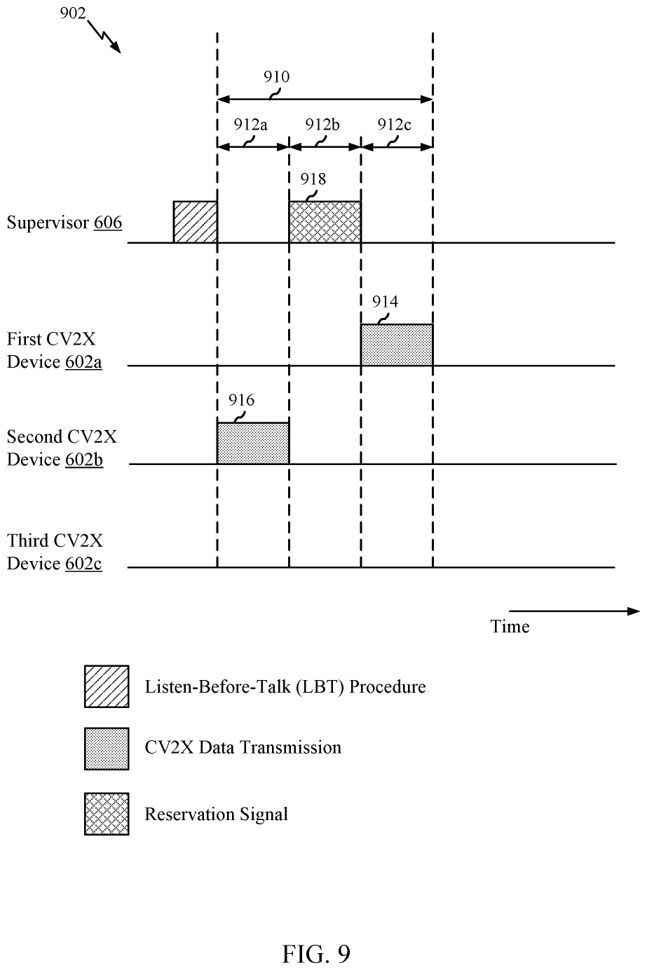

FIG. 9 is a signal diagram illustrating an example model of communication 902, by the CV2X devices 602 and supervisor 606 of FIG. 6, over a frequency band of an unlicensed spectrum. In this example, the supervisor 606 initiates reservation of a time window 910 by first performing an LBT procedure prior to the time window 910 to sense whether the frequency band is idle. The time window 910 includes three slots 912 (e.g., a first slot 912a, a second slot 912b, and a third slot 912c), though it should be understood that time window 910 may have fewer or a greater number of slots, or other suitable time periods. In response to a determination that the frequency band is idle, the supervisor 606 assigns the first slot 912a at the beginning of the time window 910 to the second CV2X device 602b for transmission of first data 916, and assigns the third slot 912c to the first CV2X device 602a for transmission of second data 914. As in FIG. 8, the third CV2X device 602c does not have any data to transmit, so less than every slot in the time window 910 is used. As such, the supervisor 606 may transmit a reservation signal 918 over the second slot 912b in the time window to prevent the time window from being not reserved. This way, the third slot is reserved for the first CV2X device 602a because non-CV2X devices are prevented from transmitting during the second slot by the reservation signal 918.

As noted, if the supervisor 606 does not transmit the reservation signal 918 during the second slot 912b, reservation of the time window 910 may be lost resulting in possibly losing third slot 912c to non-CV2X devices. However, the third slot 912c may still be used by the first CV2X device 602a even if the supervisor 606 does not transmit a reservation signal or CV2X data during the second slot 912b. In one example, the supervisor 606 may perform the LBT procedure prior to the third slot 912c to determine whether the frequency band is idle (e.g., immediately) before the third slot. If the frequency band is idle, the first CV2X device 602a may transmit during the third slot 912c. However, if the supervisor 606 detects that the frequency band is busy during the LBT, the third slot may be lost, which would prevent the first CV2X device 602a from communicating.

In order for the supervisor 606 to perform the communication management operations described above, additional signaling may be required. For example, the supervisor 606 may need to know which CV2X devices 602 are within its range and know an amount of resources needed by each of the CV2X devices 602. In some examples, the supervisor 606 may also need to inform the CV2X devices 602 about which resources (e.g., slots) have been reserved for them.

In one example, the additional signaling may be performed over a frequency band in a licensed spectrum (e.g., “licensed band”). Here, the supervisor 606 and the CV2X devices 602 may communicate resources, scheduling, and any other suitable control signaling for communication over the unlicensed band, via the licensed band. That is, signaling, by the supervisor 606 to the CV2X devices 602, regarding the presence (or negative presence) of the supervisor 606, and the geographical area of the supervisor 606, may be performed over a licensed band. In some examples, the supervisor 606 may transmit or broadcast zone identifiers to the CV2X devices 602 informing them of the range and location of the supervisor 606. In one example, the supervisor 606 may transmit/broadcast such signaling over a licensed band prior to the time window. One or more CV2X devices 602 that receive the signaling may respond to the supervisor 606 by transmitting, over the licensed band, a request for resources (e.g., slots and/or subchannels within the unlicensed frequency band) in the time window of the unlicensed frequency band. When the supervisor 606 receives the request(s) from the CV2X devices 602, the supervisor may assign resources to the CV2X devices 602 based on the requests by transmitting the assigned resources to the CV2X devices 602 over the licensed band or the unlicensed band.

In certain aspects, one or more of the CV2X devices 602 may use the licensed band to communicate a request indicating a number and/or a location of resources (e.g., slots and/or subchannels) that the corresponding one or more CV2X devices 602 request for communicating over a time window in the unlicensed band. Similarly, the supervisor 606 may utilize the licensed band to transmit resource assignments to the CV2X devices 602.

In certain aspects, the supervisor 606 and the CV2X devices 602 may be configured to operate in dual connectivity mode to support communication over both licensed and unlicensed frequency bands. In one example, the supervisor 606 and the CV2X devices 602 may continuously monitor the licensed band for the additional signaling using, for example, an LTE service, or any other suitable service. The supervisor 606 may also be configured to notify the CV2X devices 602 when a time window in the unlicensed band becomes available.

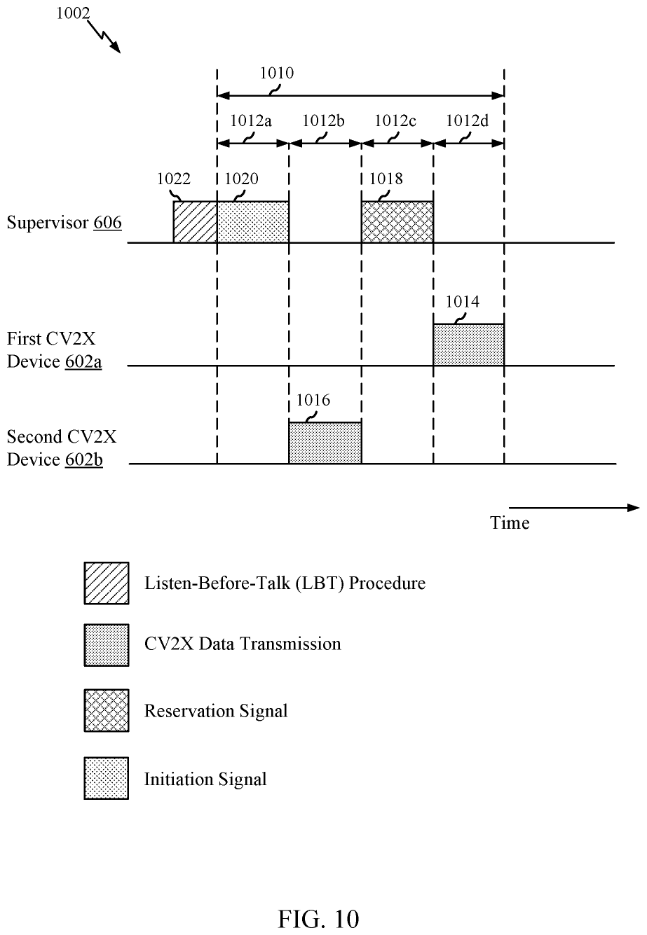

FIG. 10 is a signal diagram illustrating an example model of communication 1002, by two CV2X devices (e.g., a first CV2X device 602a and a second CV2X device 602b) and supervisor 606 of FIG. 6, over a frequency band of an unlicensed spectrum. In this example, the supervisor 606 initiates reservation of a time window 1010 by first performing an LBT procedure 1022 prior to the time window 1010 to measure whether the frequency band is idle. In response to a determination that the unlicensed frequency band is idle, the supervisor 606 transmits an initiation signal 1020, in the unlicensed frequency band, using the first slot 1012a in time at the start of the time window 1010. Here, the initiation signal 1020 notifies the first CV2X device 602a and the second CV2X device 602b that the time window 1010 has begun. In some examples, the initiation signal 1020 may include a resource assignment as well. For example, the supervisor 606 may broadcast an initiation signal 1020 that contains an indication of resources reserved for each of the two CV2X devices 602.

In the example shown in FIG. 10, the time window 1010 covers a duration of four slots (e.g., a first slot 1012a, a second slot 1012b, a third slot 1012c, and a fourth slot 1012d), though it should be noted that time window 1010 may include any suitable number of slots or other suitable time periods. Here, the slot that is first in time (e.g., the first slot 1012a in this example) is used to transmit the initiation signal 1020. Once the initiation signal 1020 is received by the CV2X devices 602, the CV2X devices 602 may proceed to transmit over the resources reserved for them as indicated by the initiation signal 1020. Here, the second slot 1012b is reserved for the second CV2X device 602b for communication of first data 1016, and the fourth slot 1012d is reserved for the first CV2X device 602a for communication of second data 1014, which leaves the third slot 1012c without an assigned device. As discussed, the supervisor 606 may transmit a reservation signal 1018 over the third slot in order to preserve the full duration of the time window 1010 and prevent non-CV2X devices 604 from interfering with the fourth slot 1012d.

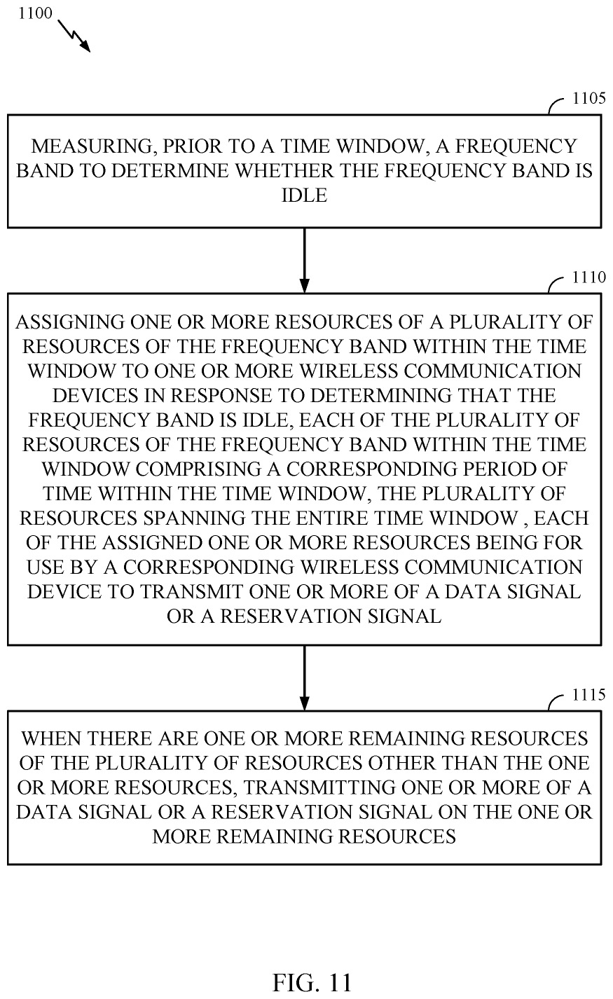

FIG. 11 is a flow diagram illustrating example operations 1100 for wireless communication, in accordance with certain aspects of the present disclosure. The operations 1100 may be performed, for example, by a BS (e.g., such as the BS 110a in the wireless communication network 100 of FIG. 1) or by a UE (e.g., such as the UE 120a in the wireless communication network 100 of FIG. 1).

Operations 1100 may be implemented as software components that are executed and run on one or more processors (e.g., controller/processor 240/280 of FIG. 2). Further, the transmission and reception of signals in operations 1100 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1100 may begin, at a first block 1105, by measuring, prior to a time window, a frequency band to determine whether the frequency band is idle.

In certain aspects, when no interference is found for the one of the plurality of time intervals (e.g., slot), operations 1100 may proceed, at a second block 1110, by assigning one or more resources of a plurality of resources of the frequency band within the time window to one or more wireless communication devices in response to determining that the frequency band is idle, each of the plurality of resources of the frequency band within the time window comprising a corresponding period of time within the time window, the plurality of resources spanning the entire time window, each of the assigned one or more resources being for use by a corresponding wireless communication device to transmit one or more of a data signal or a reservation signal.

In certain aspects, when there are one or more remaining resources of the plurality of resources other than the one or more resources, the operations 1100 proceed, at a third block 1115, by transmitting one or more of a data signal or a reservation signal on the one or more remaining resources.

In certain aspects, the frequency band is an unlicensed frequency band in an unlicensed spectrum, wherein the operations 1100 further comprise communicating over a licensed frequency band comprising: transmitting, prior to the time window, a signal indicating a presence of the device; and receiving, in response to the signal, one or more requests from the one or more wireless communication devices, each of the one or more requests indicating an amount of resources in the unlicensed frequency band within the time window requested by a corresponding wireless communication device for transmitting data, wherein the assigning the one or more resources is based on the received one or more requests.

In certain aspects, the communicating over the licensed frequency band further comprises transmitting one or more indications of the assigned one or more resources to the one or more wireless communication devices.

In certain aspects, the operations 1100 further comprise transmitting an initial signal over the frequency band at a start of the time window, the initial signal indicating the assigned one or more resources of the frequency band within the time window to the one or more wireless communication devices, the initial signal indicating the start of the time window to the one or more wireless communication devices.

In certain aspects, the operations 1100 further comprise transmitting an initial signal over the frequency band at a start of the time window, the initial signal indicating the start of the time window to the one or more wireless communication devices.

In certain aspects, the measuring the frequency band to determine whether the frequency band is idle occurs according to one or more of: a recurring pattern of time; or an amount of wireless traffic over the frequency band.

In certain aspects, the measuring comprises performing a listen-before-talk (LBT) process.

In certain aspects, the channel comprises a sidelink in an unlicensed spectrum.

In certain aspects, the sidelink is used for cellular vehicle to everything (CV2X) communication.

In certain aspects, the time window is one of a plurality of time windows.

In certain aspects, the device comprises one of a user equipment (UE), a road side unit, or a base station.

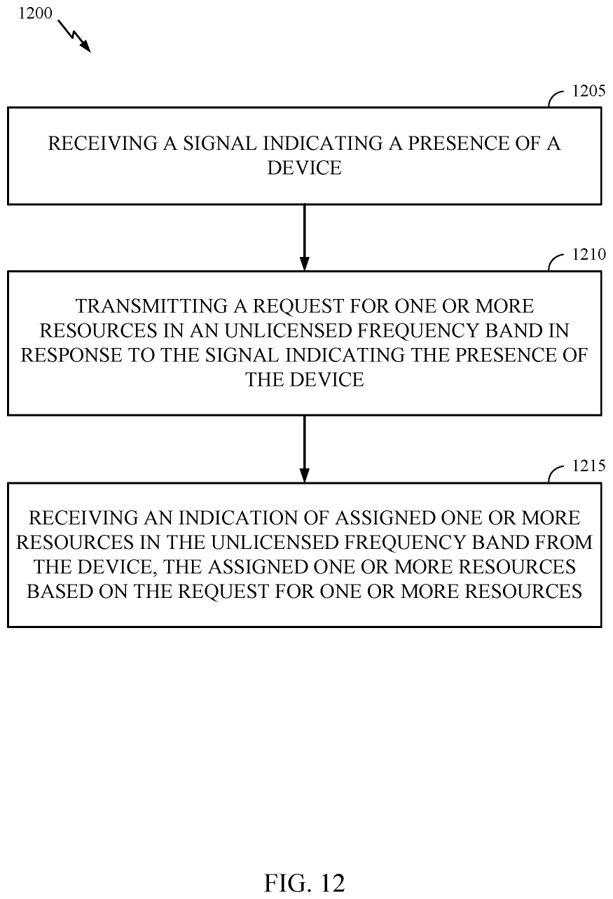

FIG. 12 is a flow diagram illustrating example operations 1200 for wireless communication, in accordance with certain aspects of the present disclosure. The operations 1200 may be performed, for example, by a UE (e.g., such as the UE 120a in the wireless communication network 100 of FIG. 1).

Operations 1200 may be implemented as software components that are executed and run on one or more processors (e.g., controller/processor 280 of FIG. 2).

Further, the transmission and reception of signals in operations 1200 may be enabled, for example, by one or more antennas (e.g., antennas 252 of FIG. 2). In certain aspects, the transmission and/or reception of signals may be implemented via a bus interface of one or more processors (e.g., controller/processor 280) obtaining and/or outputting signals.

The operations 1200 may begin, at a first block 1205, by receiving a signal indicating a presence of a device.

The operations 1200 may proceed, at a second block 1210, by transmitting a request for one or more resources in an unlicensed frequency band in response to the signal indicating the presence of the device.

The operations 1200 may proceed, at a third block 1215, by receiving an indication of assigned one or more resources in the unlicensed frequency band from the device, the assigned one or more resources based on the request for one or more resources.

In certain aspects, the signal indicating the presence is received over a licensed frequency band.

In certain aspects, transmitting the request for one or more resources in the unlicensed frequency band comprises transmitting the request over a licensed frequency band.

In certain aspects, the indication of the assigned one or more resources is received over a licensed frequency band.

In certain aspects, the assigned one or more resources are within a time window, and further comprising receiving an initial signal over the unlicensed frequency band at a start of the time window, the initial signal indicating the start of the time window.

In certain aspects, the indication of the assigned one or more resources is received in the initial signal.

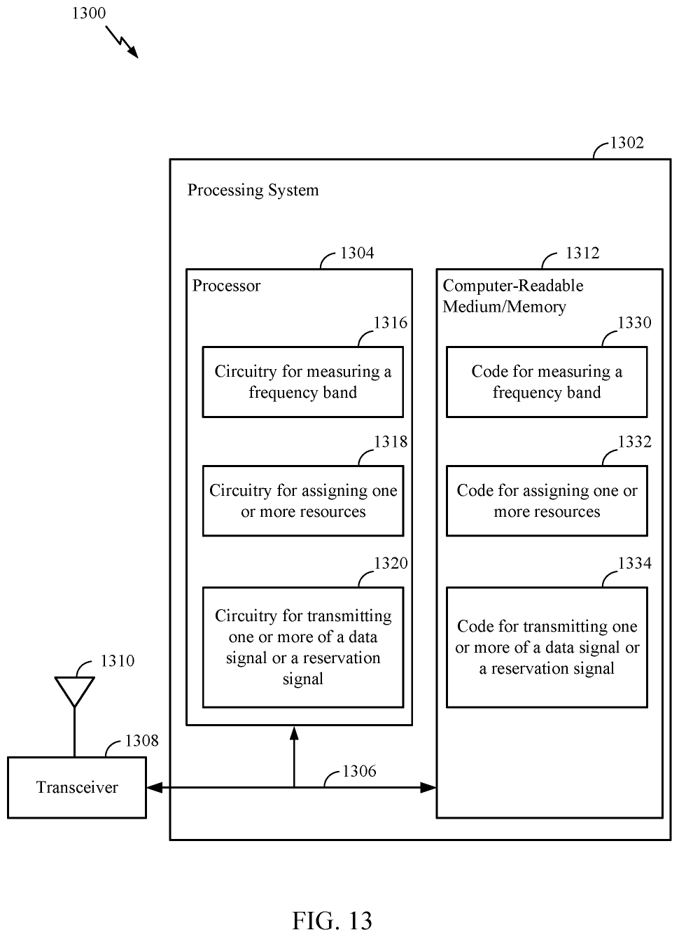

FIG. 13 illustrates a communications device 1300 that may include various components (e.g., corresponding to means-plus-function components) configured to perform operations for the techniques disclosed herein, such as the operations illustrated in FIG. 11. The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 11, or other operations for performing the various techniques discussed herein for performing sidelink communications in unlicensed bands.

In certain aspects, computer-readable medium/memory 1312 stores code 1330 for measuring, prior to a time window, a frequency band to determine whether the frequency band is idle.

In certain aspects, computer-readable medium/memory 1312 stores code 1332 for assigning one or more resources of a plurality of resources of the frequency band within the time window to one or more wireless communication devices in response to determining that the frequency band is idle, each of the plurality of resources of the frequency band within the time window comprising a corresponding period of time within the time window, the plurality of resources spanning the entire time window, each of the assigned one or more resources being for use by a corresponding wireless communication device to transmit one or more of a data signal or a reservation signal.

In certain aspects, computer-readable medium/memory 1312 stores code 1334 for when there are one or more remaining resources of the plurality of resources other than the one or more resources, transmitting one or more of a data signal or a reservation signal on the one or more remaining resources.

In certain aspects, the processor 1304 has circuitry configured to implement the code stored in the computer-readable medium/memory 1312. The processor 1304 includes circuitry 1316 for measuring, prior to a time window, a frequency band to determine whether the frequency band is idle.

In certain aspects, the processor 1304 includes circuitry 1318 for assigning one or more resources of a plurality of resources of the frequency band within the time window to one or more wireless communication devices in response to determining that the frequency band is idle, each of the plurality of resources of the frequency band within the time window comprising a corresponding period of time within the time window, the plurality of resources spanning the entire time window, each of the assigned one or more resources being for use by a corresponding wireless communication device to transmit one or more of a data signal or a reservation signal.

In certain aspects, the processor 1304 includes circuitry 1320 for, when there are one or more remaining resources of the plurality of resources other than the one or more resources, transmitting one or more of a data signal or a reservation signal on the one or more remaining resources.

For example, means for transmitting (or means for outputting for transmission) may include a transmitter and/or an antenna(s) 234 or the BS 110a or the transmitter unit 254 and/or antenna(s) 252 of the UE 120a illustrated in FIG. 2, circuitry 1320 for, when there are one or more remaining resources of the plurality of resources other than the one or more resources, transmitting one or more of a data signal or a reservation signal on the one or more remaining resources, of the communication device 1300 in FIG. 13. Means for receiving (or means for obtaining or means for measuring) may include a receiver and/or an antenna(s) 234 of the BS 110a or a receiver and/or antenna(s) 252 of the UE 120a illustrated in FIG. 2. Means for communicating may include a transmitter, a receiver or both. Means for generating, means for performing, means for filtering, means for taking action, means for determining, means for coordinating, means for assigning, and means for measuring may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2 and/or the processing system 1302 of the communication device 1300 in FIG. 13.

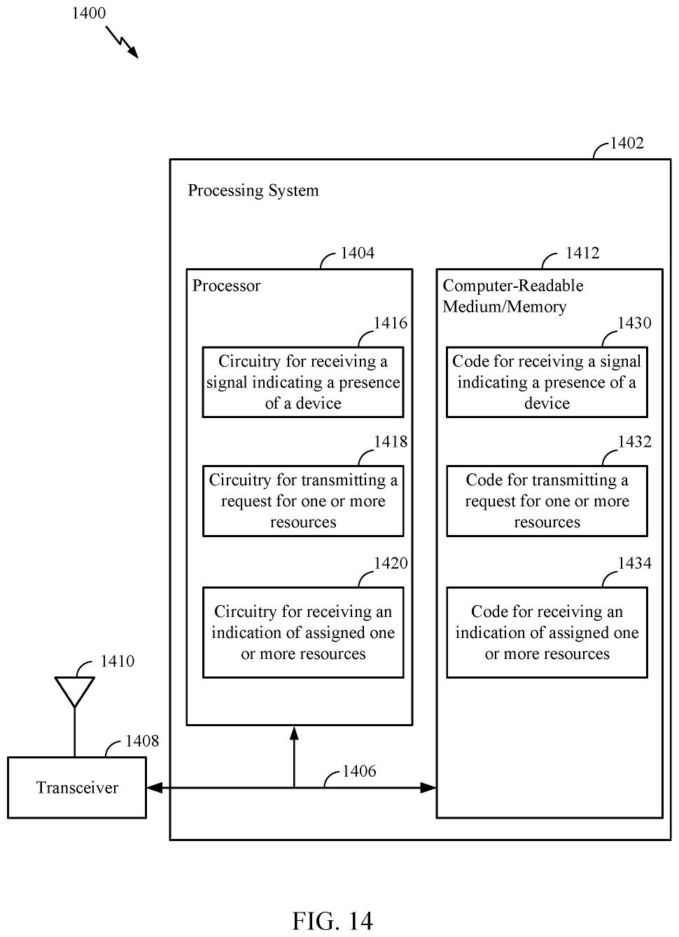

FIG. 14 illustrates a communications device 1400 that may include various components (e.g., corresponding to means-plus-function components) configured to perform operations for the techniques disclosed herein, such as the operations illustrated in FIG. 12. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 12, or other operations for performing the various techniques discussed herein for performing sidelink communications in unlicensed bands.

In certain aspects, computer-readable medium/memory 1412 stores code 1430 for receiving a signal indicating a presence of a device.

In certain aspects, computer-readable medium/memory 1412 stores code 1432 for transmitting a request for one or more resources in an unlicensed frequency band in response to the signal indicating the presence of the device.

In certain aspects, computer-readable medium/memory 1412 stores code 1434 for receiving an indication of assigned one or more resources in the unlicensed frequency band from the device, the assigned one or more resources based on the request for one or more resources.

In certain aspects, the processor 1404 has circuitry configured to implement the code stored in the computer-readable medium/memory 1412. The processor 1404 includes circuitry 1416 for receiving a signal indicating a presence of a device.

In certain aspects, the processor 1404 includes circuitry 1418 for transmitting a request for one or more resources in an unlicensed frequency band in response to the signal indicating the presence of the device.

In certain aspects, the processor 1404 includes circuitry 1420 for receiving an indication of assigned one or more resources in the unlicensed frequency band from the device, the assigned one or more resources based on the request for one or more resources.

For example, means for transmitting (or means for outputting for transmission) may include a transmitter and/or an antenna(s) 234 or the BS 110a or the transmitter unit 254 and/or antenna(s) 252 of the UE 120a illustrated in FIG. 2, circuitry 1418 for transmitting a request for one or more resources in an unlicensed frequency band in response to the signal indicating the presence of the device, of the communication device 1400 in FIG. 14. Means for receiving (or means for obtaining or means for measuring) may include a receiver and/or an antenna(s) 234 of the BS 110a or a receiver and/or antenna(s) 252 of the UE 120a illustrated in FIG. 2 and/or circuitry 1416 for receiving a signal indicating a presence of a device, and/or circuitry 1420 for receiving an indication of assigned one or more resources in the unlicensed frequency band from the device, the assigned one or more resources based on the request for one or more resources of the communication device 1400 in FIG. 14. Means for communicating may include a transmitter, a receiver or both. Means for generating, means for performing, means for filtering, means for taking action, means for determining, means for coordinating, and means for measuring may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2 and/or the processing system 1402 of the communication device 1400 in FIG. 14.

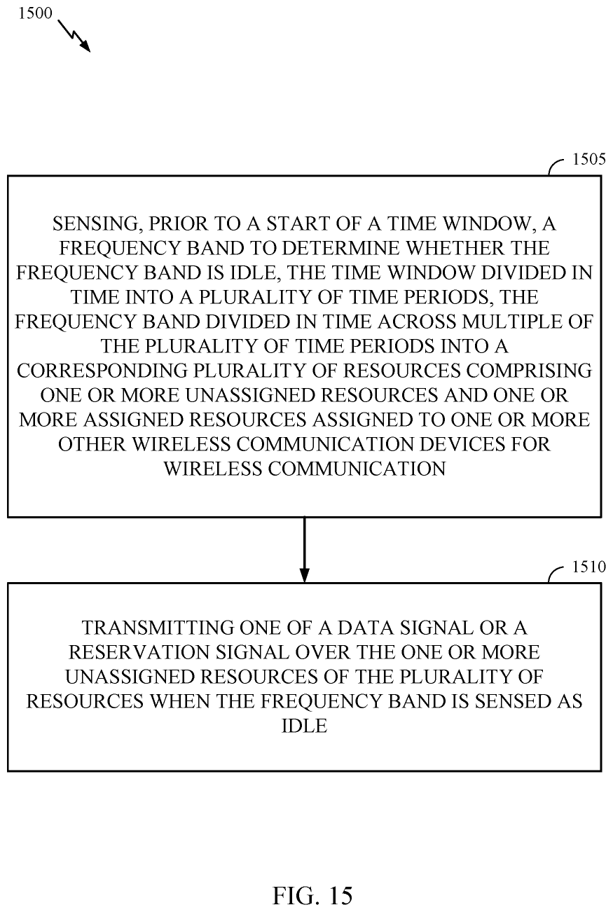

FIG. 15 is a flow diagram illustrating example operations 1500 for wireless communication, in accordance with certain aspects of the present disclosure. The operations 1500 may be performed, for example, by a BS (e.g., such as the BS 110a in the wireless communication network 100 of FIG. 1) or by a UE (e.g., such as the UE 120a in the wireless communication network 100 of FIG. 1).

Operations 1500 may be implemented as software components that are executed and run on one or more processors (e.g., controller/processor 240/280 of FIG. 2). Further, the transmission and reception of signals in operations 1500 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1500 may begin, at a first block 1505, by sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication.

The operations 1500 may proceed, at a second block 1510, by transmitting one of a data signal or a reservation signal over the one or more unassigned resources of the plurality of resources when the frequency band is sensed as idle.

It should be noted that, here, one or more unassigned resources, in certain aspects, may refer to one or more resources not assigned to other wireless communication devices, such as via signaling. However, it should be noted that any of such one or more unassigned resources, in certain aspects, may be assigned by the wireless communication device to the wireless communication device itself, and therefore the wireless communication device may transmit data over any such one or more unassigned resources.

In certain aspects, the multiple of the plurality of time periods comprises all of the plurality of time periods.

In certain aspects, the frequency band is an unlicensed frequency band, the method further comprising: transmitting, prior to the start of the time window, a signal indicating a presence of the wireless communication device, the signal transmitted over a licensed frequency band; and receiving over the licensed frequency band, from the one or more other wireless communication devices, in response to transmitting the signal, one or more requests, each of the one or more requests indicating an amount of resources requested, wherein the one or more assigned resources are assigned based on the one or more requests.

In certain aspects, the signal comprises one or more of a communication range of the wireless communication device or a location of the wireless communication device, wherein the UE is within the communication range of the wireless communication device.

In certain aspects, the communicating over the licensed frequency band further comprises transmitting one or more indications of the one or more assigned resources to the one or more other wireless communication devices.

In certain aspects, the operations 1500 include transmitting an initial signal over the frequency band at the start of the time window, the initial signal indicating the one or more assigned resources to the one or more other wireless communication devices, the initial signal indicating the start of the time window to the one or more other wireless communication devices.

In certain aspects, the sensing the frequency band to determine whether the frequency band is idle occurs according to one or more of: a recurring pattern of time; or an amount of wireless traffic over the frequency band.

In certain aspects, transmitting the one of the data signal or the reservation signal comprises transmitting over a sidelink.

In certain aspects, the wireless communication device comprises one of a user equipment (UE) or a base station.

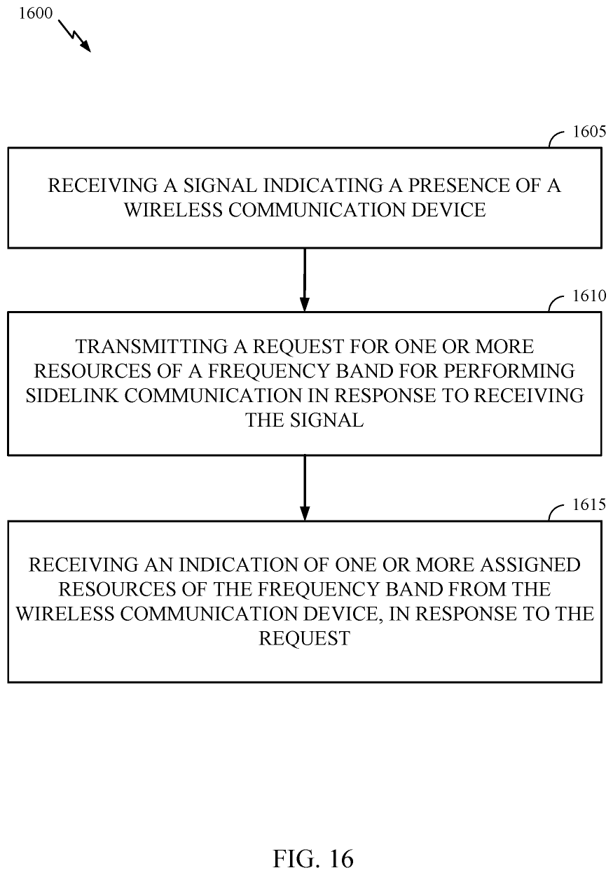

FIG. 16 is a flow diagram illustrating example operations 1600 for wireless communication, in accordance with certain aspects of the present disclosure. The operations 1600 may be performed, for example, by a UE (e.g., such as the UE 120a in the wireless communication network 100 of FIG. 1).

Operations 1600 may be implemented as software components that are executed and run on one or more processors (e.g., controller/processor 280 of FIG. 2). Further, the transmission and reception of signals in operations 1600 may be enabled, for example, by one or more antennas (e.g., antennas 252 of FIG. 2). In certain aspects, the transmission and/or reception of signals may be implemented via a bus interface of one or more processors (e.g., controller/processor 280) obtaining and/or outputting signals.

The operations 1600 may begin, at a first block 1605, by receiving a signal indicating a presence of a wireless communication device.

The operations 1600 may proceed, at a second block 1610, by transmitting a request for one or more resources of a frequency band for performing sidelink communication in response to receiving the signal.

The operations 1600 may proceed, at a third block 1615, by receiving an indication of one or more assigned resources of the frequency band from the wireless communication device in response to the request.

In certain aspects, the frequency band is an unlicensed frequency band, the method further comprising receiving the signal over a licensed frequency band.

In certain aspects, each of the one or more assigned resources comprises a resource of a plurality of resources in time of the frequency band within a time window, the time window divided in time into a plurality of time periods, the frequency band divided in time across multiple of the plurality of time periods into the plurality of resources.

In certain aspects, the operations 1600 include receiving, from the wireless communication device, one of a data signal or a reservation signal over an unassigned resource of the plurality of resources. It should be noted that, here, one or more unassigned resources, in certain aspects, may refer to one or more resources not assigned to other wireless communication devices, such as via signaling. However, it should be noted that any of such one or more unassigned resources, in certain aspects, may be assigned by the wireless communication device to the wireless communication device itself, and therefore the wireless communication device may transmit data over any such one or more unassigned resources.

In certain aspects, receiving the signal further comprises receiving the signal prior to a start of the time window.

In certain aspects, the one or more assigned resources are within a time window, and wherein the processor and the memory are further configured to receive an initial signal in the frequency band at a start of the time window, the initial signal indicating the start of the time window.

In certain aspects, the initial signal comprises the indication of the one or more assigned resources.

In certain aspects, the signal comprises one or more of a communication range of the wireless communication device or a location of the wireless communication device, wherein the UE is within the communication range of the wireless communication device.

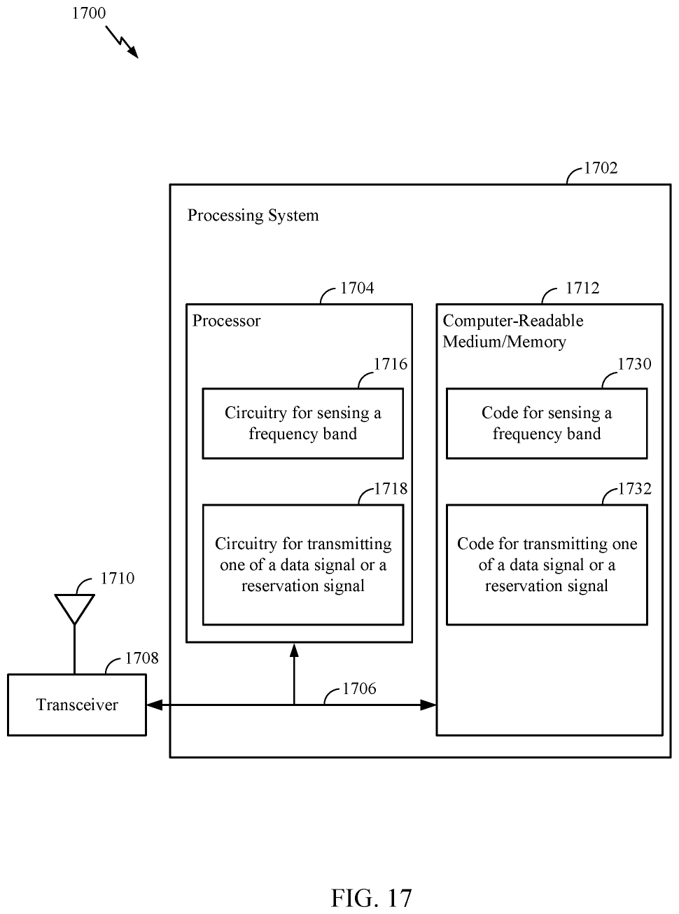

FIG. 17 illustrates a communications device 1700 that may include various components (e.g., corresponding to means-plus-function components) configured to perform operations for the techniques disclosed herein, such as the operations illustrated in FIG. 15. The communications device 1700 includes a processing system 1702 coupled to a transceiver 1708 (e.g., a transmitter and/or a receiver). The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes a processor 1704 coupled to a computer-readable medium/memory 1712 via a bus 1706. In certain aspects, the computer-readable medium/memory 1712 is configured to store instructions (e.g., computer-executable code) that when executed by the processor 1704, cause the processor 1704 to perform the operations illustrated in FIG. 15, or other operations for performing the various techniques discussed herein for performing sidelink communications in unlicensed bands.

In certain aspects, computer-readable medium/memory 1712 stores code 1730 for sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication.

In certain aspects, computer-readable medium/memory 1712 stores code 1732 for transmitting one of a data signal or a reservation signal over the one or more unassigned resources of the plurality of resources when the frequency band is sensed as idle.

In certain aspects, the processor 1704 has circuitry configured to implement the code stored in the computer-readable medium/memory 1712. The processor 1704 includes circuitry 1716 for sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication.

In certain aspects, the processor 1704 includes circuitry 1718 for transmitting one of a data signal or a reservation signal over the one or more unassigned resources of the plurality of resources when the frequency band is sensed as idle.

For example, means for transmitting (or means for outputting for transmission) may include a transmitter and/or an antenna(s) 234 or the BS 110a or the transmitter unit 254 and/or antenna(s) 252 of the UE 120a illustrated in FIG. 2, circuitry 1718 for transmitting one of a data signal or a reservation signal over one or more unassigned resources of the plurality of resources, the plurality of resources comprising the one or more unassigned resources and one or more assigned resources assigned to one or more wireless communication devices for wireless communication in response to a determination that the frequency band is idle, of the communication device 1700 in FIG. 17.

Means for sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication may include a processing system, which may include one or more processors, such as the controller/processor 240 of the BS 110a or the controller/processor 280 of the UE 120a illustrated in FIG. 2 and/or the processing system 1702 and/or the circuitry 1716 for sensing of the communication device 1700 in FIG. 17.

Means for communicating may include a transmitter, a receiver or both. Means for generating, means for performing, means for filtering, means for taking action, means for determining, means for coordinating, and means for measuring and/or sensing may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2 and/or the processing system 1702 of the communication device 1700 in FIG. 17.

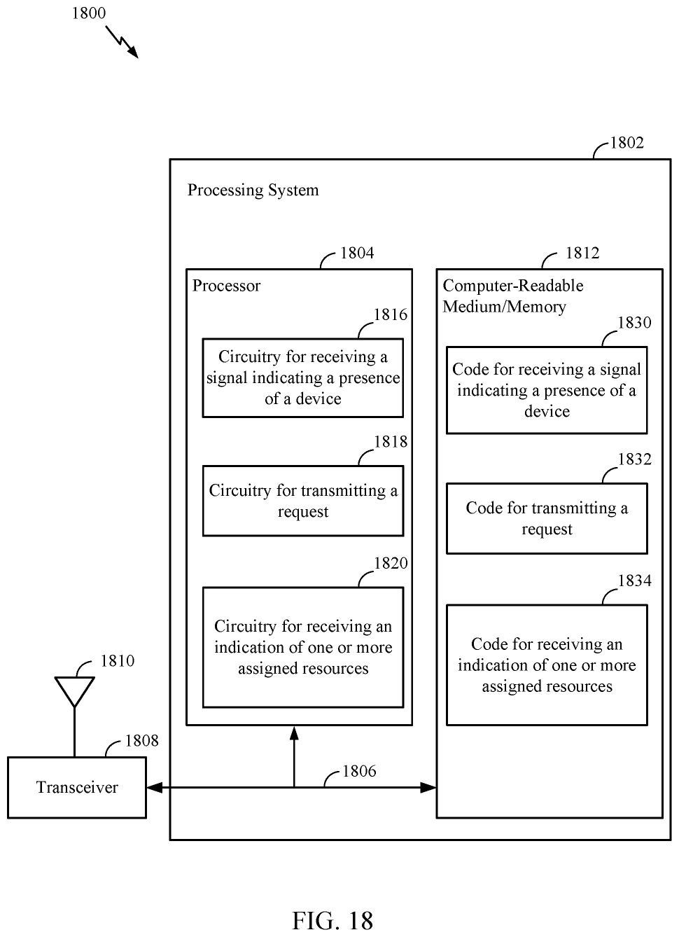

FIG. 18 illustrates a communications device 1800 that may include various components (e.g., corresponding to means-plus-function components) configured to perform operations for the techniques disclosed herein, such as the operations illustrated in FIG. 16. The communications device 1800 includes a processing system 1802 coupled to a transceiver 1808 (e.g., a transmitter and/or a receiver). The transceiver 1808 is configured to transmit and receive signals for the communications device 1800 via an antenna 1810, such as the various signals as described herein. The processing system 1802 may be configured to perform processing functions for the communications device 1800, including processing signals received and/or to be transmitted by the communications device 1800.

The processing system 1802 includes a processor 1804 coupled to a computer-readable medium/memory 1812 via a bus 1806. In certain aspects, the computer-readable medium/memory 1812 is configured to store instructions (e.g., computer-executable code) that when executed by the processor 1804, cause the processor 1804 to perform the operations illustrated in FIG. 16, or other operations for performing the various techniques discussed herein for performing sidelink communications in unlicensed bands.

In certain aspects, computer-readable medium/memory 1812 stores code 1830 for receiving a signal indicating a presence of a wireless communication device.

In certain aspects, computer-readable medium/memory 1812 stores code 1832 for transmitting a request for one or more resources of a frequency band for performing sidelink communication in response to receiving the signal.

In certain aspects, computer-readable medium/memory 1812 stores code 1834 for receiving an indication of one or more assigned resources of the frequency band from the wireless communication device in response to the request.

In certain aspects, the processor 1804 has circuitry configured to implement the code stored in the computer-readable medium/memory 1812. The processor 1804 includes circuitry 1816 for receiving a signal indicating a presence of a wireless communication device.

In certain aspects, the processor 1804 includes circuitry 1818 for transmitting a request for one or more resources of a frequency band for performing sidelink communication in response to receiving the signal.

In certain aspects, the processor 1804 includes circuitry 1820 for receiving an indication of one or more assigned resources of the frequency band from the wireless communication device in response to the request.

For example, means for transmitting (or means for outputting for transmission) may include a transmitter and/or an antenna(s) 234 or the BS 110a or the transmitter unit 254 and/or antenna(s) 252 of the UE 120a illustrated in FIG. 2, circuitry 1818 for transmitting a request for one or more resources in a sidelink communication in response to the signal indicating the presence of the device, of the communication device 1400 in FIG. 18.

Means for receiving (or means for obtaining or means for measuring) may include a receiver and/or an antenna(s) 234 of the BS 110a or a receiver and/or antenna(s) 252 of the UE 120a illustrated in FIG. 2 and/or circuitry 1816 for receiving a signal indicating a presence of a device, and/or circuitry 1820 for receiving an indication of one or more assigned resources for the sidelink communication from the device, the one or more assigned resources based on the request for one or more resources of the communication device 1800 in FIG. 18.

Means for communicating may include a transmitter, a receiver or both. Means for generating, means for performing, means for filtering, means for taking action, means for determining, means for coordinating, and means for measuring may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2 and/or the processing system 1802 of the communication device 1800 in FIG. 18.

### Example Aspects

Aspect 1: A wireless communication device, comprising: a memory; and a processor coupled to the memory, the processor and the memory configured to: sense, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication; and transmit one of a data signal or a reservation signal over the one or more unassigned resources of the plurality of resources when the frequency band is sensed as idle.

Aspect 2: The wireless communication device of Aspect 1, wherein the multiple of the plurality of time periods comprises all of the plurality of time periods.

Aspect 3: The wireless communication device of any of Aspects 1 or 2, wherein the frequency band is an unlicensed frequency band, and wherein the processor and the memory are further configured to: transmit, prior to the start of the time window, a signal indicating a presence of the wireless communication device, the signal transmitted over a licensed frequency band; and receive over the licensed frequency band, from the one or more other wireless communication devices, in response to transmitting the signal, one or more requests, each of the one or more requests indicating an amount of resources requested, wherein the one or more assigned resources are assigned based on the one or more requests.

Aspect 4: The wireless communication device of any of Aspects 1-3, wherein the processor and the memory are further configured to transmit, over the licensed frequency band, one or more indications of the one or more assigned resources to the one or more other wireless communication devices.

Aspect 5: The wireless communication device of any of Aspects 1-4, wherein the signal comprises one or more of a communication range of the wireless communication device or a location of the wireless communication device, wherein the one or more other wireless communication devices are within the communication range of the wireless communication device.

Aspect 6: The wireless communication device of any of Aspects 1-5, wherein the processor and the memory are further configured to transmit an initial signal over the frequency band at the start of the time window, the initial signal indicating the one or more assigned resources to the one or more other wireless communication devices, the initial signal further indicating the start of the time window to the one or more other wireless communication devices.

Aspect 7: The wireless communication device of any of Aspects 1-6, wherein the processor and the memory being configured to the sense the frequency band to determine whether the frequency band is idle, are further configured to sense the frequency band according to one or more of: a recurring pattern of time; or an amount of wireless traffic over the frequency band.

Aspect 8: The wireless communication device of any of Aspects 1-7, wherein the processor and the memory configured to transmit the one of the data signal or the reservation signal comprises the processor and the memory configured to transmit over a sidelink.

Aspect 9: The wireless communication device of any of Aspects 1-8, wherein the wireless communication device comprises one of a user equipment (UE) or a base station (BS).

Aspect 10: A user equipment (UE), comprising: a memory; and a processor communicatively coupled to the memory, the processor and the memory configured to: receive a signal indicating a presence of a wireless communication device; transmit a request for one or more resources of a frequency band for performing sidelink communication in response to receiving the signal; and receive an indication of one or more assigned resources of the frequency band from the wireless communication device, in response to the request.

Aspect 11: The method of Aspect 10, wherein the frequency band is an unlicensed frequency band, and wherein the processor and the memory configured to receive the signal comprises the processor and the memory configured to receive the signal over a licensed frequency band.

Aspect 12: The method of Aspect 10 or 11, wherein each of the one or more assigned resources comprises a resource of a plurality of resources in time of the frequency band within a time window, the time window divided in time into a plurality of time periods, the frequency band divided in time across multiple of the plurality of time periods into the plurality of resources.

Aspect 13: The method of any of Aspects 10-12, wherein the processor and the memory are further configured to receive, from the wireless communication device, one of a data signal or a reservation signal over an unassigned resource of the plurality of resources.

Aspect 14: The method of any of Aspects 10-13, wherein the processor and the memory configured to receive the signal comprises the processor and the memory configured to receive the signal prior to the a start of the time window.

Aspect 15: The method of any of Aspects 10-14, wherein the one or more assigned resources are within a time window, and wherein the processor and the memory are further configured to receive an initial signal in the frequency band at a start of the time window, the initial signal indicating the start of the time window.

Aspect 16: The method of any of Aspects 10-15, wherein the initial signal comprises the indication of the one or more assigned resources.

Aspect 17: The method of any of Aspects 10-16, wherein the signal comprises one or more of a communication range of the wireless communication device or a location of the wireless communication device, wherein the UE is within the communication range of the wireless communication device.

Aspect 18: A method of wireless communication by a device, comprising: sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication; and transmitting one of a data signal or a reservation signal over the one or more unassigned resources of the plurality of resources when the frequency band is sensed as idle.

Aspect 19: The method of Aspects 18, wherein the multiple of the plurality of time periods comprises all of the plurality of time periods.

Aspect 20: The method of any of Aspects 18 and 19, wherein the frequency band is an unlicensed frequency band, the method further comprising: transmitting, prior to the start of the time window, a signal indicating a presence of the wireless communication device, the signal transmitted over a licensed frequency band; and receiving over the licensed frequency band, from the one or more other wireless communication devices, in response to transmitting the signal, one or more requests, each of the one or more requests indicating an amount of resources requested, wherein the one or more assigned resources are assigned based on the one or more requests.

Aspect 21: The method of any of Aspects 18-20, wherein the communicating over the licensed frequency band further comprises transmitting one or more indications of the one or more assigned resources to the one or more other wireless communication devices.

Aspect 22: The method of any of Aspects 18-21, wherein the signal comprises one or more of a communication range of the wireless communication device or a location of the wireless communication device, wherein the one or more other wireless communication devices are within the communication range of the wireless communication device.

Aspect 23: The method of any of Aspects 18-22, further comprising transmitting an initial signal over the frequency band at the start of the time window, the initial signal indicating the one or more assigned resources to the one or more other wireless communication devices, the initial signal indicating the start of the time window to the one or more other wireless communication devices.

Aspect 24: The method of any of Aspects 18-23, wherein the sensing the frequency band to determine whether the frequency band is idle occurs according to one or more of: a recurring pattern of time; or an amount of wireless traffic over the frequency band.

Aspect 25: The method of any of Aspects 18-24, wherein transmitting the one of the data signal or the reservation signal comprises transmitting over a sidelink.

Aspect 26: The method of any of Aspects 18-25, wherein the wireless communication device comprises one of a user equipment (UE) or a base station.

Aspect 27: A method of wireless communication by a user equipment (UE), comprising: receiving a signal indicating a presence of a wireless communication device; transmitting a request for one or more resources of a frequency band for performing sidelink communication in response to receiving the signal; and receiving an indication of one or more assigned resources of the frequency band from the wireless communication device in response to the request.

Aspect 28: The method of Aspect 27, wherein the frequency band is an unlicensed frequency band, the method further comprising receiving the signal over a licensed frequency band.

Aspect 29: The method of any of Aspects 27 and 28, wherein each of the one or more assigned resources comprises a resource of a plurality of resources in time of the frequency band within a time window, the time window divided in time into a plurality of time periods, the frequency band divided in time across multiple of the plurality of time periods into the plurality of resources.

Aspect 30: The method of any of Aspects 27-30, further comprising receiving, from the wireless communication device, one of a data signal or a reservation signal over an unassigned resource of the plurality of resources.

Aspect 31: A method of wireless communication by a device, comprising: measuring, prior to a time window, a frequency band to determine whether the frequency band is idle; assigning one or more resources of a plurality of resources of the frequency band within the time window to one or more wireless communication devices in response to determining that the frequency band is idle, each of the plurality of resources of the frequency band within the time window comprising a corresponding period of time within the time window, the plurality of resources spanning the entire time window, each of the assigned one or more resources being for use by a corresponding wireless communication device to transmit one or more of a data signal or a reservation signal; and when there are one or more remaining resources of the plurality of resources other than the one or more resources, transmitting one or more of a data signal or a reservation signal on the one or more remaining resources.

Aspect 32: The method of Aspect 31, wherein the frequency band is an unlicensed frequency band in an unlicensed spectrum, the method further comprising communicating over a licensed frequency band comprising: transmitting, prior to the time window, a signal indicating a presence of the device; and receiving, in response to the signal, one or more requests from the one or more wireless communication devices, each of the one or more requests indicating an amount of resources in the unlicensed frequency band within the time window requested by a corresponding wireless communication device for transmitting data, wherein the assigning the one or more resources is based on the received one or more requests.

Aspect 33: The method of any of Aspects 31 or 32, wherein the communicating over the licensed frequency band further comprises transmitting one or more indications of the assigned one or more resources to the one or more wireless communication devices.

Aspect 34: The method of any of Aspects 31-33, further comprising transmitting an initial signal over the frequency band at a start of the time window, the initial signal indicating the assigned one or more resources of the frequency band within the time window to the one or more wireless communication devices, the initial signal indicating the start of the time window to the one or more wireless communication devices.

Aspect 35: The method of any of Aspects 31-34, further comprising transmitting an initial signal over the frequency band at a start of the time window, the initial signal indicating the start of the time window to the one or more wireless communication devices.

Aspect 36: The method of any of Aspects 31-35, wherein the measuring the frequency band to determine whether the frequency band is idle occurs according to one or more of: a recurring pattern of time; or an amount of wireless traffic over the frequency band.

Aspect 37: The method of any of Aspects 31-36, wherein the measuring comprises performing a listen-before-talk (LBT) process.

Aspect 38: The method of any of Aspects 31-37, wherein the frequency band comprises a sidelink in an unlicensed spectrum.

Aspect 39: The method of any of Aspects 31-38, wherein the sidelink is used for cellular vehicle to everything (CV2X) communication.

Aspect 40: The method of any of Aspects 31-39, wherein the time window is one of a plurality of time windows.

Aspect 41: The method of any of Aspects 31-40, wherein the device comprises one of a user equipment (UE), a road side unit, or a base station.

Aspect 42: A user equipment (UE) for wireless communication, comprising a memory and one or more processors for performing the method of any of Aspects 31-41.

Aspect 43: A user equipment (UE) comprising: one or more means for performing the method of any of Aspects 31-41.

Aspect 44: A non-transitory computer-readable storage medium having instructions stored thereon for performing the method of any of Aspects 31-41 for wireless communication by a user equipment (UE).

Aspect 55: A method of wireless communication by a user equipment (UE), comprising: receiving a signal indicating a presence of a device; transmitting a request for one or more resources in an unlicensed frequency band in response to the signal indicating the presence of the device; and receiving an indication of assigned one or more resources in the unlicensed frequency band from the device, the assigned one or more resources based on the request for one or more resources.

Aspect 56: The method of Aspect 55, wherein the signal indicating the presence is received over a licensed frequency band.

Aspect 57: The method of Aspect 55 or 56, wherein transmitting the request for one or more resources in the unlicensed frequency band comprises transmitting the request over a licensed frequency band.

Aspect 58: The method of any of Aspects 55-57, wherein the indication of the assigned one or more resources is received over a licensed frequency band.

Aspect 59: The method of any of Aspects 55-58, wherein the assigned one or more resources are within a time window, and further comprising receiving an initial signal over the unlicensed frequency band at a start of the time window, the initial signal indicating the start of the time window.

Aspect 60: The method of any of Aspects 55-59, wherein the indication of the assigned one or more resources is received in the initial signal.

Aspect 61: A user equipment (UE) for wireless communication, comprising a memory and one or more processors for performing the method of any of Aspects 55-60.

Aspect 62: A user equipment (UE) comprising: one or more means for performing the method of any of Aspects 55-60.

Aspect 63: A non-transitory computer-readable storage medium having instructions stored thereon for performing the method of any of Aspects 55-60 for wireless communication by a user equipment (UE).

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), ultra mobile broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). CdMA2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, radio frequency (RF) chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise a non-transitory computer-readable medium (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 11, 12, 15, and 16.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A wireless communication device, comprising:
a memory; and
a processor coupled to the memory, the processor and the memory configured to:
sense, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication; and
transmit one of a data signal or a reservation signal over the one or more unassigned resources of the plurality of resources when the frequency band is sensed as idle.

2. The wireless communication device of claim 1, wherein the multiple of the plurality of time periods comprises all of the plurality of time periods.

3. The wireless communication device of claim 1, wherein the frequency band is an unlicensed frequency band, and wherein the processor and the memory are further configured to:
transmit, prior to the start of the time window, a signal indicating a presence of the wireless communication device, the signal transmitted over a licensed frequency band; and
receive over the licensed frequency band, from the one or more other wireless communication devices, in response to transmitting the signal, one or more requests, each of the one or more requests indicating an amount of resources requested, wherein the one or more assigned resources are assigned based on the one or more requests.

4. The wireless communication device of claim 3, wherein the processor and the memory are further configured to transmit, over the licensed frequency band, one or more indications of the one or more assigned resources to the one or more other wireless communication devices.

5. The wireless communication device of claim 3, wherein the signal comprises one or more of a communication range of the wireless communication device or a location of the wireless communication device, wherein the one or more other wireless communication devices are within the communication range of the wireless communication device.

6. The wireless communication device of claim 1, wherein the processor and the memory are further configured to transmit an initial signal over the frequency band at the start of the time window, the initial signal indicating the one or more assigned resources to the one or more other wireless communication devices, the initial signal further indicating the start of the time window to the one or more other wireless communication devices.

7. The wireless communication device of claim 1, wherein the processor and the memory being configured to the sense the frequency band to determine whether the frequency band is idle, are further configured to sense the frequency band according to one or more of:
a recurring pattern of time; or
an amount of wireless traffic over the frequency band.

8. The wireless communication device of claim 1, wherein the processor and the memory configured to transmit the one of the data signal or the reservation signal comprises the processor and the memory configured to transmit over a sidelink.

9. The wireless communication device of claim 1, wherein the wireless communication device comprises one of a user equipment (UE) or a base station (BS).

10. A user equipment (UE), comprising:
a memory; and
a processor communicatively coupled to the memory, the processor and the memory configured to:
receive a signal indicating a presence of a wireless communication device;
transmit a request for one or more resources of a frequency band for performing sidelink communication in response to receiving the signal; and
receive an indication of one or more assigned resources of the frequency band from the wireless communication device, in response to the request.

11. The UE of claim 10, wherein the frequency band is an unlicensed frequency band, and wherein the processor and the memory configured to receive the signal comprises the processor and the memory configured to receive the signal over a licensed frequency band.

12. The UE of claim 10, wherein each of the one or more assigned resources comprises a resource of a plurality of resources in time of the frequency band within a time window, the time window divided in time into a plurality of time periods, the frequency band divided in time across multiple of the plurality of time periods into the plurality of resources.

13. The UE of claim 12, wherein the processor and the memory are further configured to receive, from the wireless communication device, one of a data signal or a reservation signal over an unassigned resource of the plurality of resources.

14. The UE of claim 12, wherein the processor and the memory configured to receive the signal comprises the processor and the memory configured to receive the signal prior to the a start of the time window.

15. The UE of claim 10, wherein the one or more assigned resources are within a time window, and wherein the processor and the memory are further configured to receive an initial signal in the frequency band at a start of the time window, the initial signal indicating the start of the time window.

16. The UE of claim 15, wherein the initial signal comprises the indication of the one or more assigned resources.

17. The UE of claim 10, wherein the signal comprises one or more of a communication range of the wireless communication device or a location of the wireless communication device, wherein the UE is within the communication range of the wireless communication device.

18. A method of wireless communication by a device, comprising:
sensing, prior to a start of a time window, a frequency band to determine whether the frequency band is idle, the time window divided in time into a plurality of time periods, the frequency band divided in time across multiple of the plurality of time periods into a corresponding plurality of resources comprising one or more unassigned resources and one or more assigned resources assigned to one or more other wireless communication devices for wireless communication; and
transmitting one of a data signal or a reservation signal over the one or more unassigned resources of the plurality of resources when the frequency band is sensed as idle.

19. The method of claim 18, wherein the multiple of the plurality of time periods comprises all of the plurality of time periods.

20. The method of claim 18, wherein the frequency band is an unlicensed frequency band, the method further comprising:
transmitting, prior to the start of the time window, a signal indicating a presence of the wireless communication device, the signal transmitted over a licensed frequency band; and
receiving over the licensed frequency band, from the one or more other wireless communication devices, in response to transmitting the signal, one or more requests, each of the one or more requests indicating an amount of resources requested, wherein the one or more assigned resources are assigned based on the one or more requests.

21. The method of claim 20, wherein the communicating over the licensed frequency band further comprises transmitting one or more indications of the one or more assigned resources to the one or more other wireless communication devices.

22. The method of claim 20, wherein the signal comprises one or more of a communication range of the wireless communication device or a location of the wireless communication device, wherein the one or more other wireless communication devices are within the communication range of the wireless communication device.

23. The method of claim 18, further comprising transmitting an initial signal over the frequency band at the start of the time window, the initial signal indicating the one or more assigned resources to the one or more other wireless communication devices, the initial signal indicating the start of the time window to the one or more other wireless communication devices.

24. The method of claim 18, wherein the sensing the frequency band to determine whether the frequency band is idle occurs according to one or more of:
a recurring pattern of time; or
an amount of wireless traffic over the frequency band.

25. The method of claim 18, wherein transmitting the one of the data signal or the reservation signal comprises transmitting over a sidelink.

26. The method of claim 18, wherein the wireless communication device comprises one of a user equipment (UE) or a base station.

27. A method of wireless communication by a user equipment (UE), comprising:
receiving a signal indicating a presence of a wireless communication device;
transmitting a request for one or more resources of a frequency band for performing sidelink communication in response to receiving the signal; and
receiving an indication of one or more assigned resources of the frequency band from the wireless communication device in response to the request.

28. The method of claim 27, wherein the frequency band is an unlicensed frequency band, the method further comprising receiving the signal over a licensed frequency band.

29. The method of claim 27, wherein each of the one or more assigned resources comprises a resource of a plurality of resources in time of the frequency band within a time window, the time window divided in time into a plurality of time periods, the frequency band divided in time across multiple of the plurality of time periods into the plurality of resources.

30. The method of claim 29, further comprising receiving, from the wireless communication device, one of a data signal or a reservation signal over an unassigned resource of the plurality of resources.
